(19) United States
(12) Patent Application Publication
(10) Pub. No.: US 2015/0178786 A1
(43) Pub. Date: Jun. 25, 2015

(54) Pictollage: Image-Based Contextual Advertising Through Programmatically Composed Collages

(71) Applicant: Catharina A.J. Claessens, Amsterdam (NL)

(72) Inventor: Catharina A.J. Claessens, Amsterdam (NL)

(21) Appl. No.: 14/140,018

(22) Filed: Dec. 24, 2013

(51) Int. Cl. G06Q 30/02; G06F 17/30

(52) U.S. Cl. CPC G06Q 30/0269; G06Q 30/0277; G06F 17/30946

(57) ABSTRACT

A system and method for creating and serving image-based contextual advertising through programmatically composed image collages, including the procurement, indexing and matching of query images, the procurement, indexing and matching of web images and the transferring of indexed and matched data from those web images to the query images, the procurement, indexing and matching of product images to be used as collage ad components, the matching and selection of one or more decorative template elements and one or more structural templates, the programmatic combining of the product images and the templates and template elements into a collage and the distribution of this collage for display to a user as a collage ad, based at least in part on the visual data extracted and indexed from the query image.

### CROSS-REFERENCE TO RELATED APPLICATION

This application claims the benefit of U.S. Provisional Application No. 61/745,783, filed Dec. 25, 2012.

### TECHNICAL FIELD

The disclosed embodiments relate generally to the field of online advertising, and more specifically, to the presentation of contextual advertisements, consisting of collages of textual and non-textual elements, the content of which is determined at least in part by content of a non-textual nature.

### BACKGROUND OF THE INVENTION

The proliferation of digital image capturing devices and the explosive growth of online social media have led to a rapidly growing number of online photos in public photo collections and on photo sharing websites. At the same time, the rise of online design focus, combined with the ever increasing attractiveness of the interface of recent mobile devices—especially tablets—have inspired many publishers to increase the visual attractiveness of their website, by, among others, focussing on adding more imagery and photos. As photos are more salient and comprehended much faster than text, while communicating information faster than video, they are well suited for web usage. Thus, photos have become a fundamental part of this stage of the web's maturation cycle, as well as a critical aspect of the modern web experience. The web is estimated to already hold 3.5 trillion of them, and photos are supposed to occupy already 40 percent of web pixel space. Nowadays, we even see an advent of websites, such as published by TUMBLR™, PINTEREST™ and likewise publishers, relying predominantly or even solely on images and image sharing as their content strategy.

In the online industry, advertising has become an indispensable aspect of the web browsing experience and has become a key revenue source, equal to its place in just about any other commercial media market or setting. Businesses interested in finding new customers and generating revenues have adopted contextual advertising to reach just that, as many research studies have shown that contextual online advertising—analyzing the text of a web page to identify keywords that are used for selecting relevant advertisements for placement on this web page—is providing a more integrated and therefore better user experience and thus is increasing the probability of clicks, which in turn brings larger revenues to advertisers. The advent of contextual advertising has made a major impact on the earnings of many websites, reason why almost all of the for-profit non-transactional web sites (that is, sites that do not sell anything directly) rely at least in part on revenue from contextual advertising, from individual weblogs and small niche communities to large news sites from publishers such as major newspapers.

GOOGLE™ AdSense was the first major contextual advertising network and still is the most successful and popular. AdSense operates by providing webmasters with a small script that, when inserted into web pages, displays relevant textual or display advertisements from the Google inventory of advertisers. These advertisers may enroll through Ad Words, the main advertising product of GOOGLE™, offering cost-per-click (CPC) and cost-per-mille (CPM) advertising, and site-targeted advertising for text, display, and mobile ads. Nowadays, a large part of GOOGLE™'s earnings comes from its share of the contextual advertisements served on the millions of web pages running the AdSense program.

Subsequently, many technology and/or service providers have emerged with their own proprietary systems and technologies for contextual advertising, and this form of advertising has become a full-grown industry.

Contextual advertising conventionally engages the textual part of a web page and depends on text and metadata to be able to determine the keywords to be used for ad selection. Therefore, however successful contextual advertising, it is not well suited for image-rich web communities such as photo sharing sites, serendipity communities, inspirational blogs, and comparable image-focused websites, as these type of sites offer sparse or no textual content with their images and if they do contain textual content, this content is often of a subjective and/or personal nature. Thus, conventional contextual ad serving algorithms may often come empty and may be unable to contextually target an ad on such websites. As such, there is a need for enabling the selection of contextual ads by taking the image data into account, next to or instead of the textual data and metadata surrounding the image.

Further, contextual advertising relies on the level of relevancy of the ad to be shown and a plurality of research studies has shown that the more relevant the ad, the better the user experience provided and thus the higher the probability of clicks and revenue generation. As conventional algorithms are based on the information, provided by the advertiser, related to the target audience for an ad and the contents of an ad, the mapping of a relevant ad to an image, especially where textual context is non-existent or subjective, may be cumbersome at best in the conventional approach. As such, it is desirable to have a method and system for dynamically composing advertising content, that not only is contextually aligned with both the image's text and image data and takes the actual content of an image into account, but that also utilizes that data to compose an ad that is relevant to the image.

Yet further, is is desirable that the ad composed is visually appealing, and suitable for display on image oriented web pages. Those web pages are inspirational in nature and thus, are best suited by ads that display a similar appeal. Therefore, there is a need for enabling the creation of contextual ads that fit the inspirational environment they are shown in.

The users of image oriented web pages and mobile apps are accustomed to deriving inspiration from beautiful imagery, such as the photos being made available on image-rich web sites, followed by receiving additional information, which often takes the form of relevant and/or similar products, arranged in a visually attractive way, separately but thematically on the page. E.g., fashion, lifestyle, home deco, and other special interest magazines, feature reports with full page photography, often followed by pages with mood boards or collages of products, relevant to the report shown on the previous pages, to ‘get the look’.

Thus, to align with the habits and expectations of users in the ‘offline’ world, to enable a good contextual match between the online ad shown and the image, and to provide an inspirational and well-fitting commercial element, it is desirable to create a collage of ad components, acting as a relevant visual summary for the image on which the ad is targeted, while at the same time being appealing to the viewer.

Last, for a visually appealing contextual ad creation, selection and delivery system to be viable in the current market of ever growing availability of web images, it is required to provide an automated process for extracting image and text data from web images, as well as to provide a programmatic method for selecting and composing ads or ad components, visually and contextually matched to the data, extracted from the procured image.

Manual methods of generating image collages are known. For example, by using commercial image editing software, a collection of product images may be manually segmented, cropped, layered, resized, rotated and combined to form a manually generated collage that is pleasant and logical to the human eye. However, this is a highly time consuming task that requires significant skill and knowledge on the part of the creator. To enable a similar solution for digital use, there is a need for a programmatic process to arrive at a visually appealing image collage, by extracting image and/or text data from web images, and by selecting and composing ad components, visually and contextually matched to this data. Such process should take human factors such as logical relationships in scale (e.g., a couch is a larger object than a vase), logical relationships in context (e.g., a tooth brush doesn't fit in a kitchen environment and a dining chair belongs with a dining table), and logical relationships in style and color (e.g., a contemporary object does not belong in a nostalgic setting) into account, to be pleasing to the humans' eye.

### BRIEF SUMMARY OF THE INVENTION

The following presents a simplified summary of the disclosure in order to provide a basic understanding to the reader. This summary is not an extensive overview of the disclosure and it does not identify key and/or critical elements of the invention or delineate the scope of the invention. Its sole purpose is to present some concepts disclosed herein in a simplified form as a prelude to the more detailed description that is presented later.

In the preferred embodiments, the approach of the present invention is to construct a visually appealing collage ad, contextually matched with an image on a web page, mobile page or any other content area. The components of the collage ad are matched on the image data, such as high level or low level features of the image, and textual data, such as metadata and semantic data, associated with the image or directly surrounding the image.

The ad components used to create the collage ad may consist of images (e.g., product images), for example supplied by third parties such as merchants, one or several types of templates and/or template elements, and any amount of additional visual and textual elements and/or information. These ad components are programmatically selected and combined into a visually pleasing collage. The collage generated may then be coupled with additional data, distributed and presented to a user in a display area. For example, but not meant to be limiting, the collage may be rendered and combined with product information, distributed through an advertising system, and displayed as a collage ad on a web page.

Under some embodiments, amongst the ad components described above may be objects of merchandise, such as product images, which may be associated with product descriptions, price information, deep links to an external product page, etc., to be shown to a user through an annotation on the product image, populating the collage ad.

Among the numerous embodiments described herein, embodiments include systems and methods for search, retrieval and analysis of images from owned and/or third-party sites and network locations, using (non-textual) image data, semantic and/or text data and metadata. In some implementations, a method of analyzing an image may comprise crawling a large-scale image database and/or a network (for example, the internet) to gather images and their corresponding image data and text data. Visual information is extracted from the images, the extracted visual features are hashed, and the images are clustered. In some embodiments, the resulting hash values are reduced even further and are stored, together with semantic and other textual data, extracted from the images and/or their direct surroundings.

A query image, to be enriched with a collage ad, is procured, analyzed, and indexed, based upon the image data and the text data of that image. Image similarity search is performed on the stored images, and available data is transferred to the query image, using some elegant matching algorithms. In some embodiments, the systems and methods for detecting and analyzing images may utilize modules for object recognition based upon semantic data, textual data, metadata and/or image data and may further utilize modules for concept recognition, multi-feature object class recognition or any combination thereof. The systems may also include a manual interface that is configured to interface with one or more human editors, in order to correct or remove any information that is incorrectly determined from the images.

Embodiments described herein include systems and methods for matching the detected textual data and visual data, such as the detected concepts, objects and object classes, from query images to pre-defined databases with objects, including objects that are items of commerce or merchandise. Such objects may be product images and related data (e.g., text data and image data), as provided by third parties, such as advertisers and/or merchants, or any other type of images, owned or externally procured.

Embodiments include systems and methods for combining the matched objects with one or several templates, template elements, and/or other ornamental or structural elements into a visually appealing user appearance. In some embodiments, such user interface may take the form of a collage ad, in which one or several pre-produced templates and/or programmatically combined template elements may be programmatically populated with matched items of commerce, merchandise or products. In other embodiments, other visual appearances, with or without an e-commerce purpose, may be possible.

Under some embodiments, systems and methods for distributing the collage, containing for example products, decorative template elements and other components, over a network, which may include any type of wired or wireless communication channel, are included. Such distribution channel may, under some embodiments, encompass an image-based contextual advertising system.

Embodiments described herein further include components, modules, and sub-processes that comprise aspects or portions of other embodiments described herein.

While described individually, the foregoing aspects are not mutually exclusive and any number of aspects may be present in a given implementation.

### BRIEF DESCRIPTION OF THE DRAWINGS

The present description will be better understood from the following detailed description read in light of the accompanying drawings, wherein:

FIG. 1 is a schematic diagram of an exemplary system 100 in which embodiments of the present invention may be employed.

FIG. 2 is a block diagram of the structure of the image-based contextual advertising system, as shown in FIG. 1.

FIG. 3 contains a schematic diagram showing in more detail a part of the system of FIG. 2; the image procurement and pre-process system.

FIG. 4 is a schematic diagram showing in more detail a part of the system of FIG. 2; the storage and indexing system.

FIG. 5 is a block diagram of an exemplary method for image data matching, utilized by the system shown in FIG. 4.

FIG. 6a shows a block diagram of an exemplary method for procuring, indexing and storing web image content items, utilized by the systems of FIG. 3 and FIG. 4.

FIG. 6b shows a block diagram of an exemplary method for procuring, indexing and storing product image content items, utilized by the systems of FIG. 3 and FIG. 4.

FIG. 6c illustrates an exemplary method for the data extraction, indexing and matching of query image content items is shown, utilized by the systems of FIG. 3 and FIG. 4.

FIG. 7 is a schematic diagram of an exemplary image similarity matching system, a part of the system of FIG. 2.

FIG. 8 illustrates an exemplary collage composition system, a part of the system of FIG. 2.

FIG. 9a illustrates an example of an ornamental template, containing several layers, as used in an actual set-up of an embodiment of the invention.

FIG. 9b provides an example of a collage ad, composed of several product and ornamental layers, as used in an actual set-up of an embodiment of the invention.

FIG. 10a is a flow diagram of the first part of an example image collage generation process in accordance with the invention.

FIG. 10b is a flow diagram of the second part of an example image collage generation process in accordance with the invention.

FIG. 11 is a diagram functionally illustrating an advertising system, part of one or more embodiments of the invention.

FIG. 12a shows a screen shot of a user interface, exemplary for the invention.

FIG. 12b shows a second screen shot of a user interface, exemplary for the invention.

FIG. 12c shows a third screen shot of a user interface, exemplary for the invention.

FIG. 12d shows a fourth screen shot of a user interface, exemplary for the invention.

FIG. 12e shows a fifth screen shot of a user interface, exemplary for the invention.

FIG. 12f shows a sixth screen shot of a user interface, exemplary for the invention.

FIG. 12g shows a last screen shot of a user interface, exemplary for the invention.

FIG. 13 illustrates an exemplary environment and device in which embodiments of the invention may be implemented.

In the following detailed description of the invention, like reference numerals are used to designate like parts in the accompanying drawings.

### DETAILED DESCRIPTION OF THE INVENTION

Although the present examples are described and illustrated herein as being implemented in an image-based contextual advertising system for two-dimensional images, the system described is provided as an example and not a limitation. As those skilled in the art will appreciate, the present examples are suitable for application in a variety of different types of contextual advertising systems, including those where the target image elements are three-dimensional or those where the target elements are multimedia elements, e.g., video. Similarly, the examples provided are suitable for application in several non-advertising systems, as one skilled in the art will understand.

In the following detailed description in connection with the appended drawings of embodiments of the present invention, numerous specific details are set forth in order to provide a more thorough understanding of the present invention. However, it will be apparent to one skilled in the art that the present invention may be practiced without one or more of these specific details, and that the following detailed description of example embodiments is not intended to represent the only forms in which the present invention may be constructed or utilized. The same or equivalent functions and sequences may be accomplished by different examples.

Although ample examples have been provided for, well-known features may not have been described in too much detail to avoid unnecessarily complicating the description.

### I. DEFINITION OF TERMS

As used herein, the terms “advertising”, “advertisement” or “ad” are intended to mean any form of communication in which one or more products are identified and promoted. Ads may not be limited to commercial promotions or other communications. An ad may be a public service announcement or any other type of notice. For example, on the internet, “advertising” may correspond to online advertising through an advertising network, but may also represent commercial communication within a website, e.g., promotions on the (sub-) homepage of a web shop. Another example of “advertising” may be an automated suggestion of similar products to a web user, or any other form of presenting companies, products, services or skills.

The term “advertiser” in the context of the invention is meant to mean any entity that is associated with ads, and may provide, or be associated with, products related to ads. An advertiser may pursue commercial goals, public goals, charitable goals, communication goals, informative goals and/or any other goals, supported by the use of ads.

As used herein, the term “publisher” may depict any entity that generates, maintains, provides, presents, and/or processes content, business to consumer and/or business to business.

As used herein, the terms “web” and “network” may include any system or element that facilitates communications among and between various network nodes, shared, public or private, wired or wireless. A distinct example of a “web” or a “network” is the internet, but other communication systems are meant to be considered part of the terms “web” and “network” as well.

The term “product”, as used in this disclosure, is meant to depict any item or service that satisfies a market's want or need and may mean any physical item, service, idea, message, person, organization or other item, identified and/or promoted in an ad.

As used herein, the terms “programmatic”, “programmatically” or variations thereof mean through execution of code, programming or other logic. A programmatic action may be performed with software, firmware and/or hardware, and generally without user intervention, albeit not necessarily automatically, as the action may be manually triggered or may need manual moderation and/or manual enrichment.

As used herein, the term “image data” is intended to mean data that corresponds to or is based on discrete portions of a captured image. For example, with digital images, “image data” may correspond to data or information about pixels that form the image, or data or information determined from pixels of the image. Another example of “image data” is a signature, fingerprint or other non-textual data form that represents a classification or identity of the image or an object in the image. “Image data” may also encompass (a set of) global or local features.

The terms “semantic data” and “text data” in the context of an image are intended to mean data that is descriptive of that image, e.g., an image title. Such data may also correspond to textual information, added to an image, such as descriptions, tags, comments, reviews and other written data, which relates to the image and is generally stored together with that image or in the direct environment of that image.

The term “metadata” in the context of an image is meant to mean data providing information about one or more aspects of the image file, e.g., the file name, file type and/or file size. “Metadata” is also intended to refer to data that may be written into an image file identifying the owner, copyright information, camera information and other information, related to the image file. Such “metadata” may include data from well-known metadata standards such as, among others, IPTC, XMP, Exif, and/or may include Creative Commons or comparable license information. Last, “metadata” may refer to data providing information about the usage of an image, such as GPS coordinates (e.g., latitude and longitude).

The terms “recognize”, “recognition”, or variants thereof, in the context of an image or image data, is meant to mean that a determination is made as to what the image or elements or portions contained therein correlate to, represent, identify, mean, consist of and/or as to a context provided by the image or elements or portions contained therein.

### II. GENERAL OVERVIEW OF SYSTEM

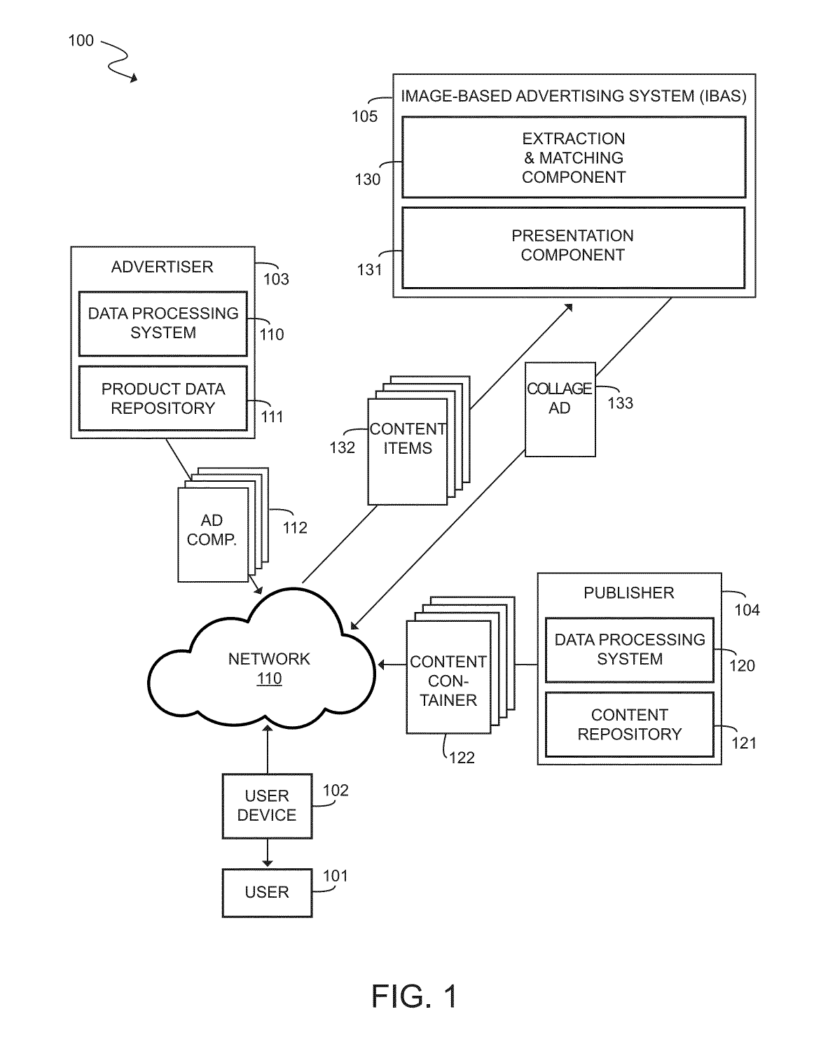

With reference to FIG. 1, a block diagram is provided illustrating an exemplary system 100 in which embodiments of the present invention may be employed. The system 100 may receive content from users, advertisers, and publishers and may provide content to users, advertisers, and publishers. For example, this content may include web documents, links, texts, images, advertisements, and other information.

Among other components not shown, the system 100 may include a user 101, using a user device 102, an advertiser 103, using a data processing system 110 and a product data repository 111, and a publisher 104, using a data processing system 120 and a content repository 121. The inventor provided the image-based advertising system (IBAS) 105, consisting of an extraction & matching component 130 and a presentation component 131, interacting with the other elements, shown in FIG. 1, in unique and novel ways that will be described in various embodiments below. All the elements that are shown in FIG. 1 use network 110.

It should be understood that any number of user devices, advertiser systems, publisher systems and IBAS components may be employed within the system 100 within the scope of the present invention. Each may comprise a single device or multiple devices cooperating in a distributed environment. Although the components are shown as separate entities in FIG. 1, they may be combined into one entity or be omitted altogether, in some embodiments. Additionally, other components not shown may be included within the system 100.

The network 110 may include any element or system that facilitates communications among and between various network nodes, such as elements 102, 103, 104, and 105. The network 110 may include one or more computer networks, telephone or other communications networks, the internet, etc. The network 110 may further include a shared, public, or private data network (e.g., an intranet, a peer-to-peer network, a private network, a virtual private network (VPN), etc.) encompassing a local area (e.g., LAN) or a wide area (e.g., WAN). The network 110 may facilitate wired and/or wireless connectivity and communication.

The advertiser 103 may include any entity that is associated with ads and/or other commercial communication forms. The advertiser 103 may provide, or be associated with, products and/or services related to ads. For example, the advertiser 103 may include, or be associated with, merchants, retailers, wholesalers, warehouses, manufacturers, distributors, or any other product or service providers or distributors. The advertiser 103 may directly or indirectly generate, maintain, and/or track ads, which may be related to products or services offered by or otherwise associated with the advertiser. The advertiser 103 may include, use, or maintain, one or more data processing systems 110, such as servers or embedded systems, connected to the network 110. In one or more embodiments, the advertiser 103 may also include, use, or maintain, one or more product data repositories 111 for storing product data and other information.

The publisher 104 may include any entity that generates, maintains, provides, presents, and/or processes content in the system 100. The content may include various types of content including web-based information, such as articles, discussion threads, reports, video, graphics, search results, web page listings, information feeds (e.g., RSS feeds), television broadcasts, etc. The publisher 104 may include or maintain one or more data processing systems 120, such as servers or embedded systems, connected to the network 110. In some implementations, the publisher 104 may include one or more content repositories 121 for storing content and other information.

In some implementations, the publisher 104 may include content providers. For example, content providers may include those with an internet presence, such as online publication and news providers (e.g., online newspapers, online magazines, television websites, etc.), and online service providers (e.g., photo sharing sites, video sharing sites, social networks, etc.). The publisher 104 may also include television broadcasters, radio broadcasters, satellite broadcasters, and other content providers. The publisher 104 may represent one or more content networks that are associated with the IBAS 105.

In some implementations, the publisher 104 may include search services. For example, search services may include those with an internet presence, such as online search services that search the worldwide web, online knowledge database search services (e.g., dictionaries, encyclopedias), and online service or product database search services (e.g., restaurant sites, real estate sites, recipes sites).

The publisher 104 may provide or present content via various mediums and in various forms, including web based and non-web based mediums and forms. The publisher 104 may generate and/or maintain such content and/or retrieve the content from other network resources.

A publisher (e.g., publisher 104) may receive a request from a user device (e.g., user device 102). For example, a publisher may receive a request for content or a search query request for search results. In response, the publisher may retrieve the requested content (e.g., access the requested content from the content repository 121) and provide or present the content in the form of one or many content containers 122 to the user device 102, or the publisher may retrieve relevant search results (e.g., lists of web page titles, snippets of text extracted from those content containers, hypertext links to those content containers, and thumbnails of those pages or images on those pages, which may be grouped into a predetermined number of search results, displayed in one or many content containers 122) for the query from an index of documents or web pages, e.g., held in the content repository 121.

The publisher may also submit a request for one or more ads to the IBAS 105, for inclusion in content container 122, e.g., a web page. The ad request may include the content in the content container 122, e.g., images, text, and/or video, and associated information, such as metadata or text data. The ad request may also include the search query (as entered or parsed), information based on the query, and/or information associated with, or based on, the search results. This information may include the content itself, a category corresponding to the content or the content request (e.g., interior decoration, fashion, lifestyle, etc.), geo-location information, and all sorts of other information, all combined in content items 132, submitted as a request to IBAS 105.

In response to the ad request, the extraction & matching component 130 of IBAS 105 may extract data from the submitted content, may extract additional information, provided by the publisher 104, may match this data to ad components (e.g., ad components 112, provided by, e.g., advertiser 103), may match this data to a variety of other ad components (e.g., elements stored in extraction & matching component 130) and additional elements and may provide the selected ad components to the presentation component 131 of the IBAS 105. The presentation component 131 may then combine the selected components, render them and present them as a visually appealing, contextually matched image-based ad (e.g., collage ad 133) to the requesting publisher (e.g., publisher 104), or to a user device (e.g., user device 102).

A user device (e.g., user device 102) may present in a viewer (e.g., a browser or other content display system) the content or search results, held in the content containers 122, integrated with one or more of the collage ads 133 provided by the IBAS 105.

The user device 102 may include devices capable of accessing network 110 and receiving information from network 110. The user device 102 may include general computing components and/or embedded systems optimized with specific components for performing specific tasks. Examples of user device 102 may include personal computers (e.g., desktop computers), mobile computing devices (e.g., laptop computers), cell phones, smart phones, media players, media recorders, music players, game consoles, media centers, electronic tablets, personal digital assistants (PDA's), television systems, removable storage devices, navigation systems, set top boxes, and other electronic devices.

In some embodiments, the IBAS 105 may receive a request for one or more ads (e.g., collage ad 133) directly from a user device (e.g., user device 102). For example, the IBAS 105 may receive such request through a browser plug-in of a browser, implemented on user device 102. In other embodiments, the IBAS 105 may receive an ad request directly from a user device (e.g., user device 102), for example through a manually generated or triggered request, submitted by a user (e.g., user 101). For example, although without limitation, such a request may be a request to refresh the ad (e.g., collage ad 133).

In some implementations, in addition to content, the publisher 104 may integrate or combine retrieved content with collage ads 133 that are related or relevant to the retrieved content for display to users. The IBAS 105 may provide the publisher 104 relevant collage ads 133 to combine with content to present in a viewer on a user device 102. In some implementations, the publisher 104 may retrieve content (e.g., images) for display on a particular user device (e.g., user device 102) and may then send the content to the user device 102 along with code that causes one or more collage ads 133 from the IBAS 105 to be displayed to the user. In some implementations, the publisher 104 may retrieve content, retrieve one or more relevant collage ads 133 from the IBAS 105, and then pre-integrate the ads and the retrieved content to form a content page for display to a user (e.g., user 101), upon request.

In some embodiments, the network 110 may contain demand side advertising platforms and supply side advertising platforms. In other embodiments, the IBAS 105 itself may act as an ad exchange, a demand side advertising platform, or supply side advertising platform. In yet other embodiments, the IBAS 105 may be an internal system, integrated with a platform, e.g., an e-commerce site, by which internal promotion ‘ads’ are provided to be displayed on that platform. In this embodiment, the advertiser 103 and the publisher 104 are the same party.

The IBAS 105 may provide various services to the advertiser 103, the publisher 104, and the user 101. The IBAS 105 may store collage ads 133 and facilitate the distribution and/or targeting of these collage ads through the system 100 to the user device 102. The IBAS 105 may include one or more extraction & matching components 130 that may procure and extract data from content (e.g., as held in content containers 122) from a publisher (e.g., publisher 104), and may procure and process data (e.g., ad components 112) from advertisers. The components 130 may index and contextually match the procured advertiser data, e.g., ad components 112, to the procured publisher data, e.g., from content containers 122, thus selecting the best matching ad components 112 for inclusion in an image-based contextual ad (e.g., collage ad 133). One or more presentation components 131 in the IBAS 105 may perform functionalities associated with combining advertiser data (e.g. ad components 112) with other ad components, such as contextually matched decorative elements, to form one or more image collage ads, such as collage ad 133, and may distribute the collage ad 133 from the advertiser 103 through the publisher 104 to the user 101. Such collage ad 133 is relevant in some way to the content, held in content containers 122 (e.g., an image or a multimedia object) that is being viewed or was recently opened by the user 101.

In some implementations, the user device 102 may transmit information about the ads back to the IBAS 105, including information describing how, when, and/or where the collage ads 133 are to be or were rendered (e.g., in HTML or JavaScript®). In some implementations, the user 101, the user device 102, the advertiser 103 and the publisher 104 may provide usage information to the IBAS 105 (e.g., whether or not a conversion or click-through related to a collage ad 133 has occurred). This usage information may include measured or observed user behavior related to the collage ads presented. For example, the IBAS 105 may perform financial transactions, such as crediting publisher 104 and charging advertiser 103, based on the usage information.

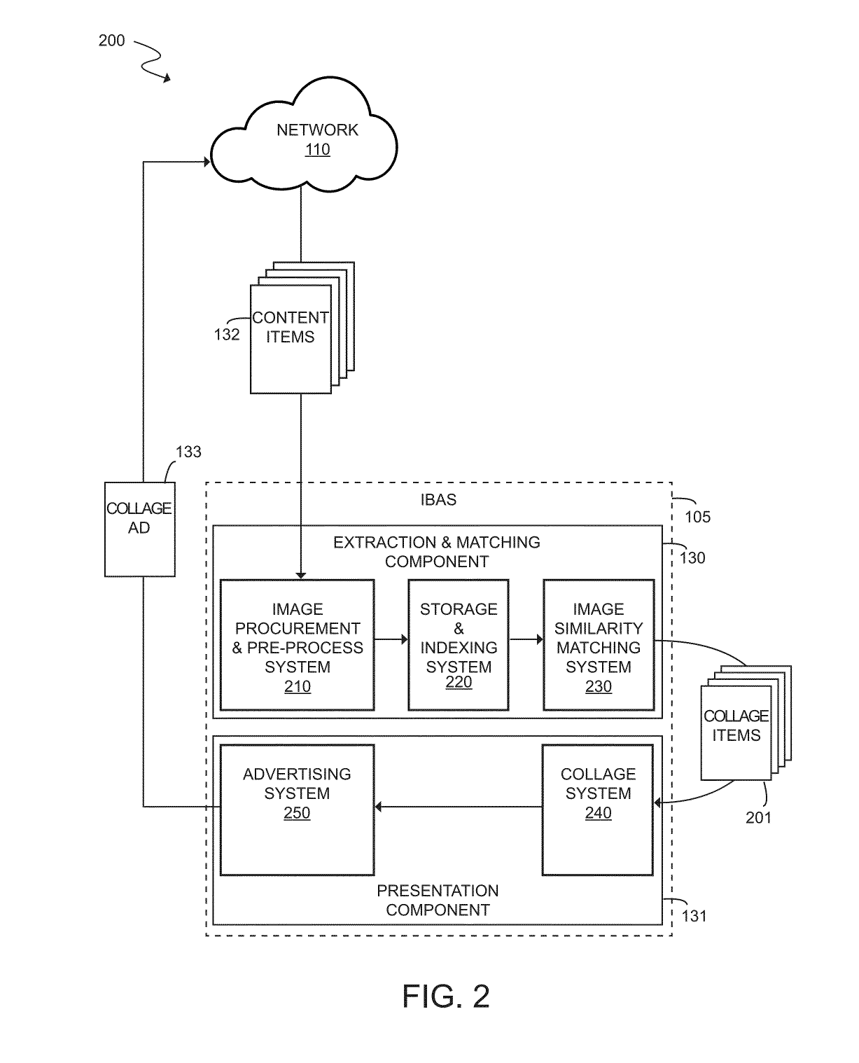

Referring now to FIG. 2, a system 200 is shown, consisting of a block diagram of the IBAS 105, containing one or more extraction & matching components 130, for procuring, extracting and matching content items, such as content items 132, consisting of (extracts of) ad components 112 and content containers 122, and one or more presentation components 131, for combining contextually matched data, such as a sub-set of ad components 112, with other elements into an image collage ad, such as collage ad 133, and presenting such collage ad, under an exemplary embodiment of the invention.

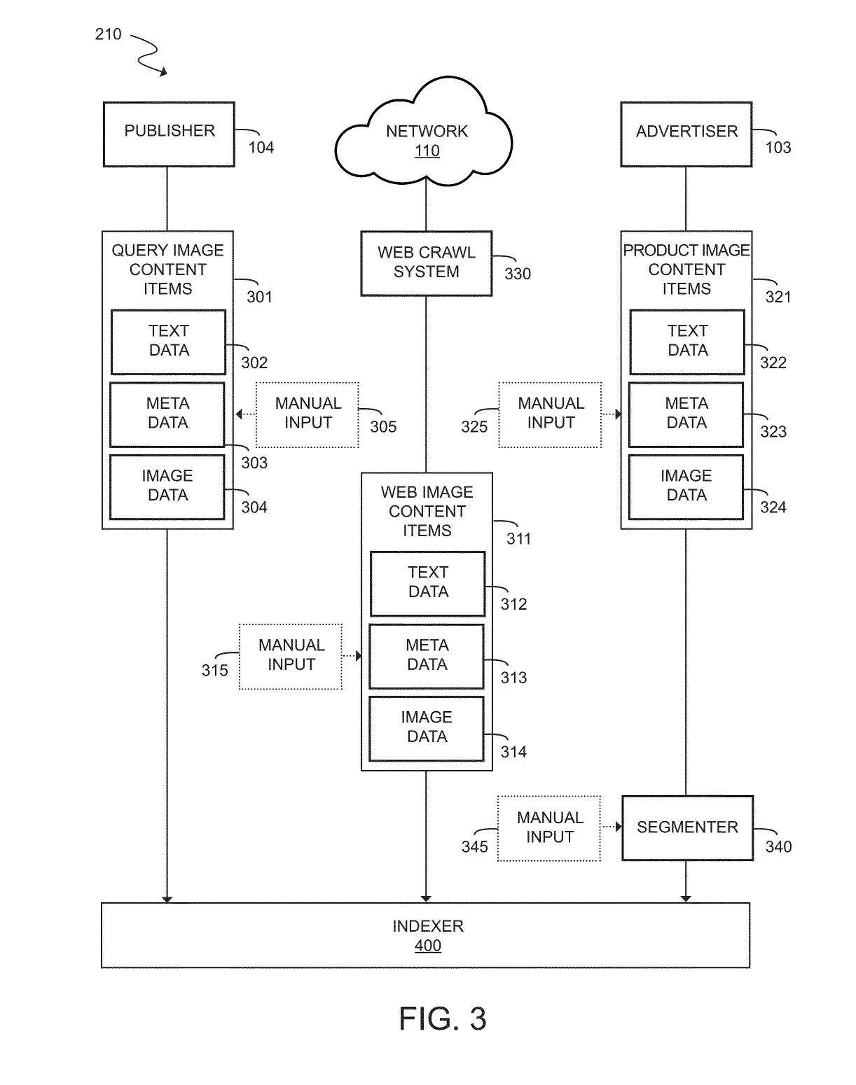

In some embodiments, the extraction & matching component 130 may contain an image procurement & pre-process system 210. System 210 may procure content items (e.g., content items 132), extract information from these content items and execute one or more of the available content editing processes on the content items procured. System 210 is described in more detail below, and illustrated in further detail in accompanying FIG. 3.

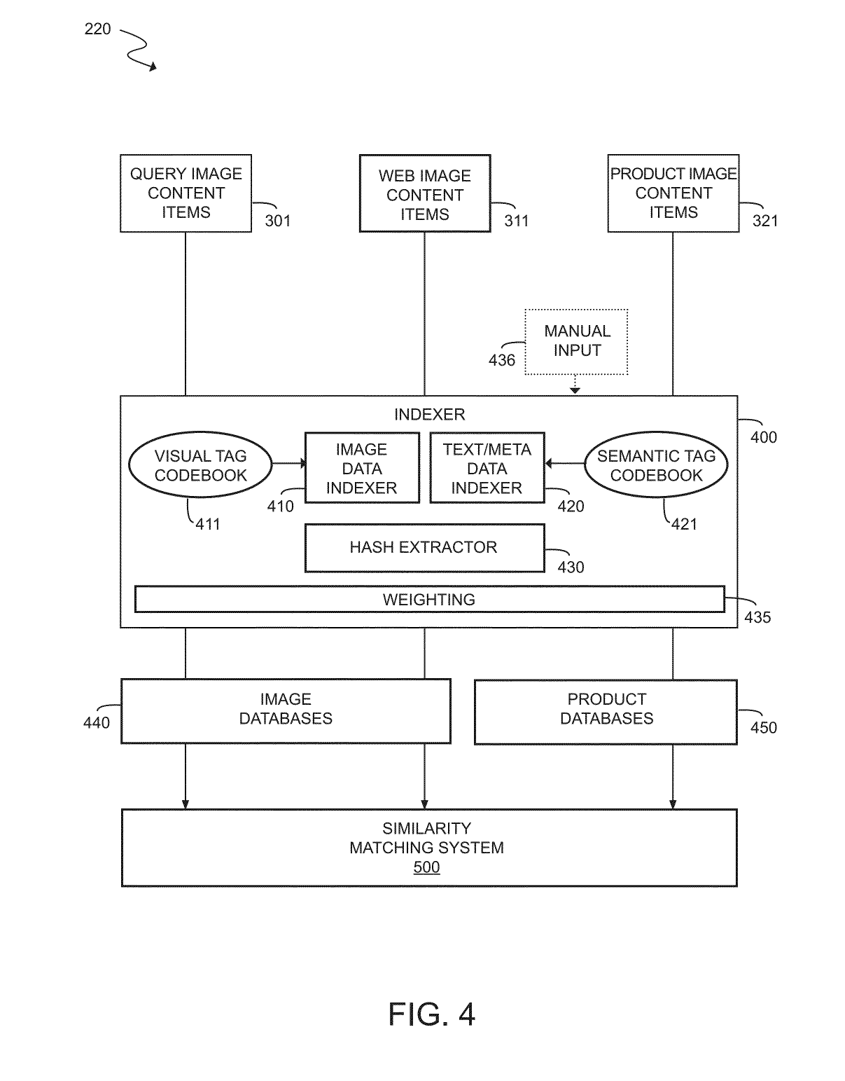

The data, extracted by the image procurement & pre-process system 210 from the content items (e.g., content items 132), may be indexed and, in some embodiments, may be stored into one or more databases by a storage & indexing system 220, using one or several of the many technologies available for indexing, storing and retrieving data from content items such as image data, text data and metadata, all pertaining to the content procured, e.g., content items 132. The storage & indexing system 220 is described in more detail below, and illustrated in further detail in accompanying FIG. 4.

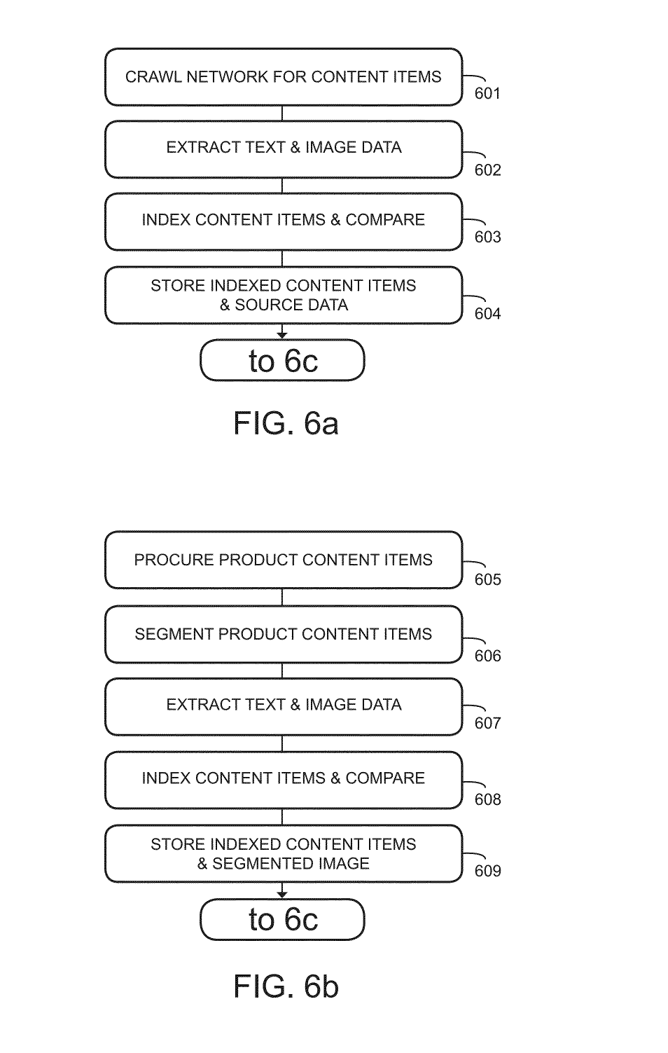

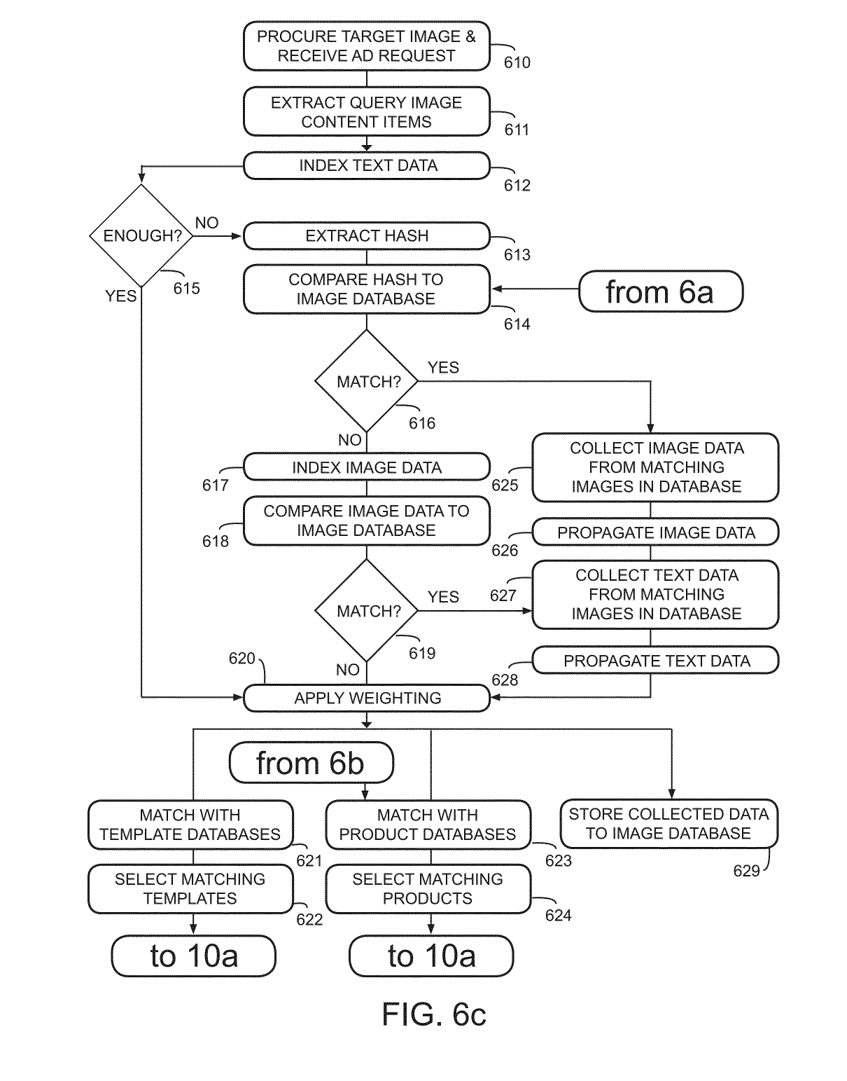

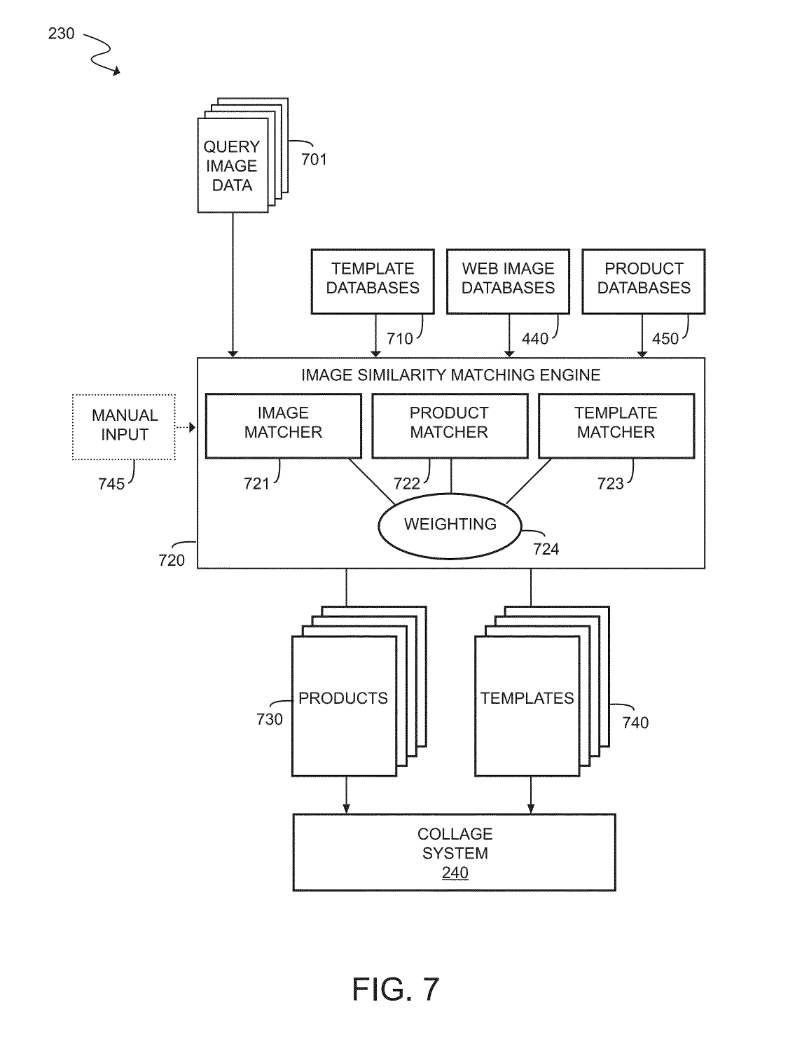

In some implementations of the invention, the data, indexed and stored by storage & indexing system 220, may be contextually matched by an image similarity matching system 230. The functionalities of system 230 are described below and an exemplary structure of system 230 is shown in FIG. 7. The matching procedure, used in some embodiments by the system 230, which is described in further detail below and illustrated in detail in FIGS. 6a, 6b and 6c, may result in a set of collage items 201, acting as input for the presentation component 131 of IBAS 105.

Presentation component 131 may contain one or more collage systems 240. The collage system 240 may create an image-based collage ad (e.g., collage ad 133), using collage items 201 as input, together with one or several additional inputs and/or ad components, following a novel collage mapping and composition method. For example, the collage system 240 may combine pre-processed product images (e.g., ad components 112 of FIG. 1), collage templates and decorative elements into one or more image collage ads, e.g., collage ad 133.

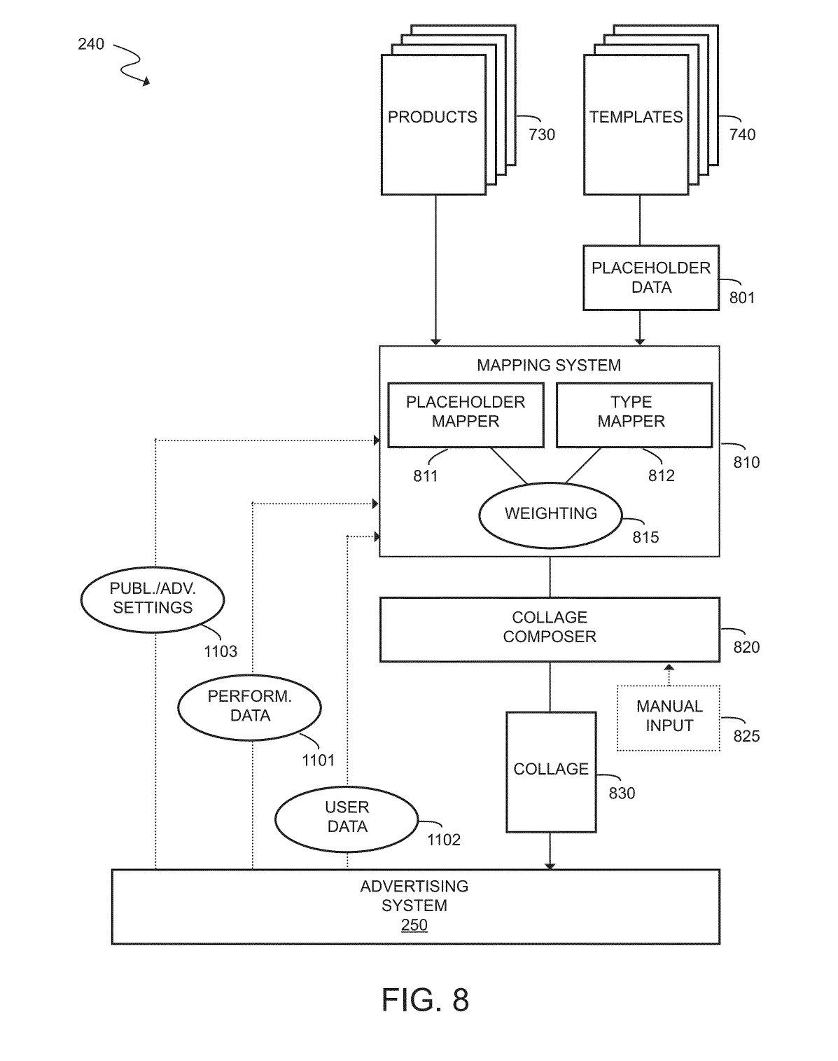

Collage system 240 is described in more detail below, and is illustrated in further detail in accompanying FIG. 8.

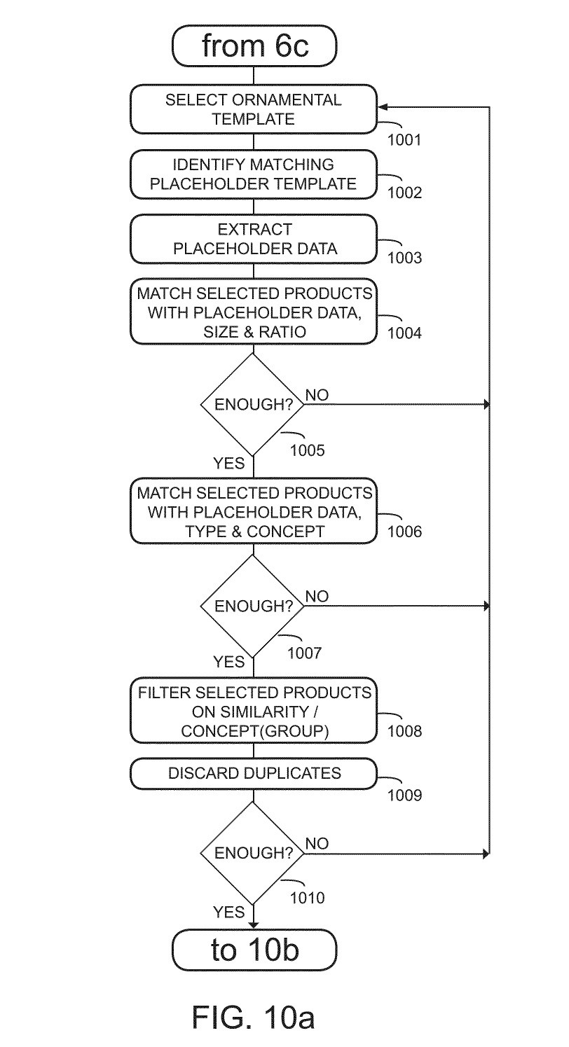

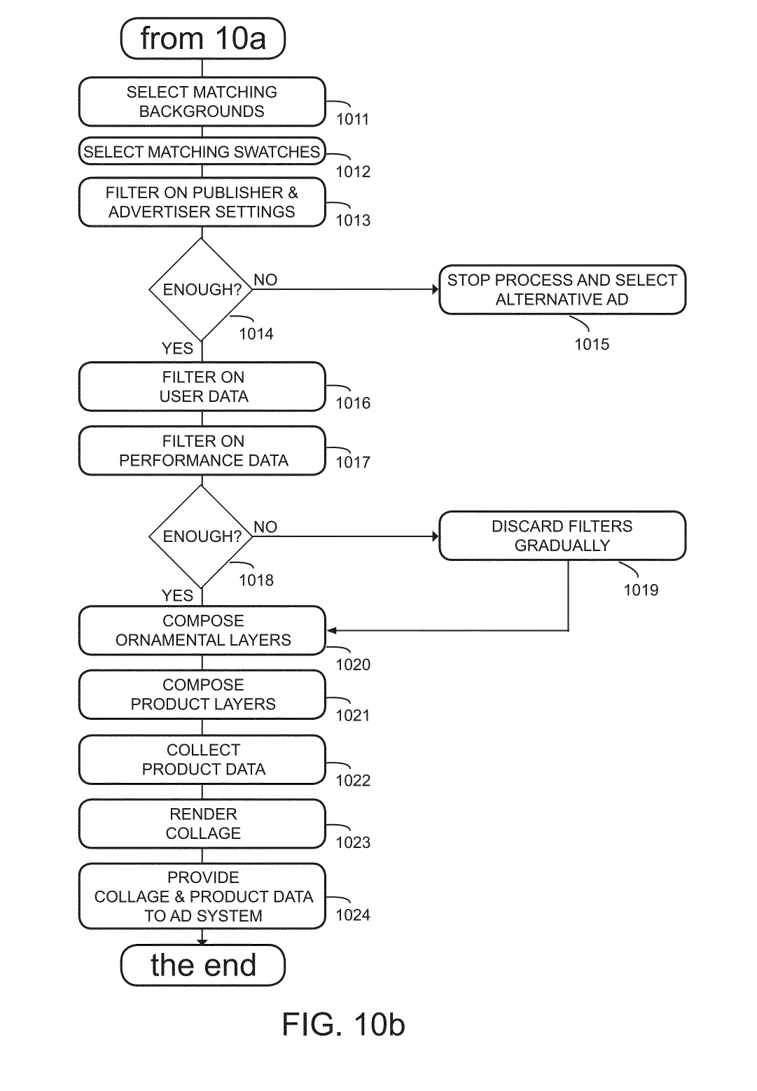

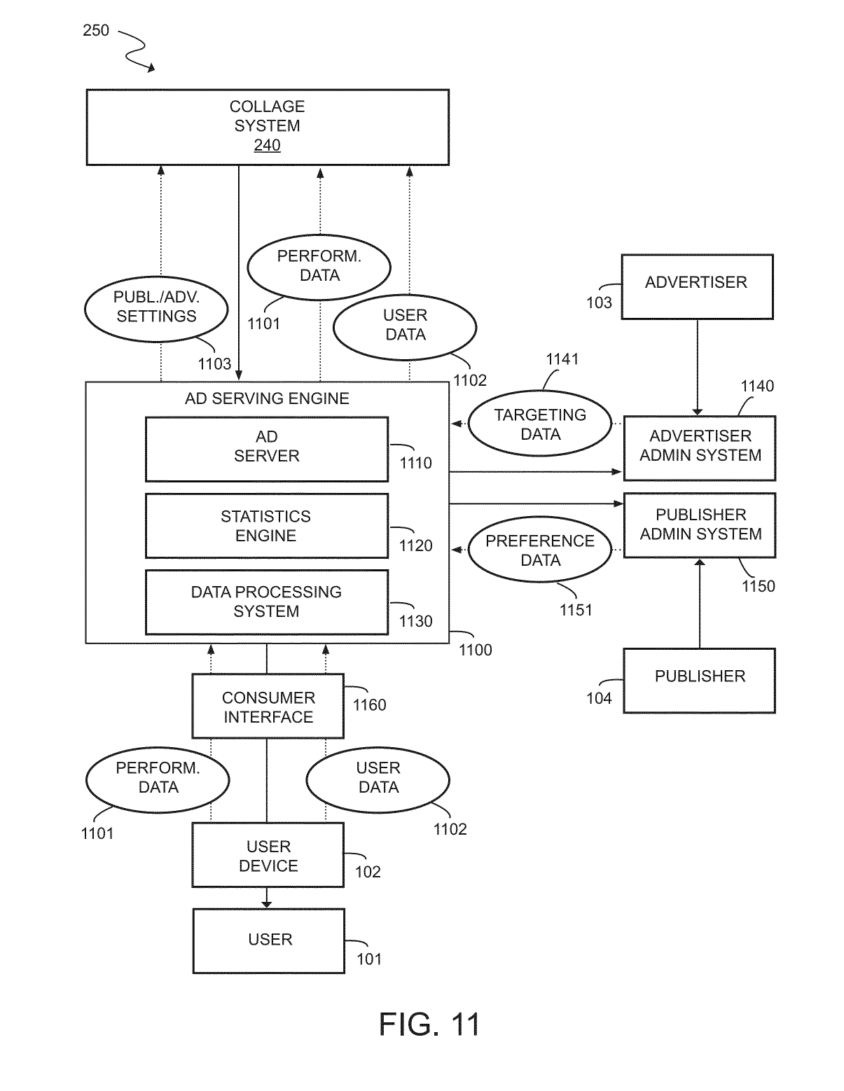

Finally, in some embodiments, the one or more collage ads 133 may be distributed by an advertising system 250. System 250 may serve an image-based contextual advertisement, such as collage ad 133, to users (e.g., user 101) directly or via a publisher (e.g., publisher 104) through network 110. The functionalities of system 250 are described in further detail below, and illustrated in further detail in accompanying FIG. 11. The methods, used by presentation component 131 are illustrated in FIGS. 10a and 10b.

For purposes of explanation only, certain aspects of this disclosure are described with reference to the discrete elements illustrated in FIG. 1 and FIG. 2. The number, identity and arrangement of elements in the system 100 and the system 200 are not limited to what is shown. For example, the system 100 may include any number of geographically dispersed advertisers 103, publishers 104, users 101 and/or user devices 102, which may be discrete, integrated modules or distributed systems. Similarly, the system 100 is not limited to one single IBAS 105 and may include any number of integrated or distributed image-based ad systems or elements of image-based ad systems. Further, the system 200 may include any number of integrated or distributed extraction & matching components or elements thereof and may include any number of integrated or distributed presentation components or elements thereof, using all or only some of the modules shown, in the described order or otherwise. Last, the system 200 may omit the usage of any of the components or modules shown altogether.

### III. IMAGE PROCUREMENT AND PRE-PROCESSING

FIG. 3 is showing a schematic diagram of the image procurement & pre-process system 210, under some implementations of the invention.

In several embodiments, system 210 may operate on query image content items 301, provided by a publisher (e.g., publisher 104). The query image content items 301 may, for example, include graphic elements and records or web content that package graphic elements along with text and/or metadata. Specific examples of content items 301 for use with embodiments described herein include images, together with titles, tags, descriptions, metadata and other information, relating to those images or to those image files, displayed on web pages (e.g., e-commerce sites, blogs, news sites, image sharing sites, search sites, etc.), contained in mobile applications, or uploaded by users (e.g., user 101). Other content items may include images and other content, uploaded by persons, other than users, or content otherwise provided to the system 210. Yet other content items may include video or other multimedia content.

In performing various analysis operations on the query image content items 301, system 210 may determine and/or use information that is descriptive or identifiable to the procured image itself or to objects shown in the image. Accordingly, system 210 may analyze, select and procure query image content items 301 to enable the IBAS 105 to a) recognize or otherwise determine information about the central theme of the image (e.g., “kitchen”, “bathroom”, “women's apparel”, “wedding”) and other relevant information of the image, through an analysis of text data 302, metadata 303, image data 304, or any combination thereof; b) recognize or otherwise determine information about an object or multiple objects contained in the image, through an analysis of text data 302, metadata 303, image data 304, or any combination thereof, and/or c) recognize or otherwise determine information about the image, an object in the image or multiple objects in the image using existing or known information from a source other than the procured query image content items 301, such as, for example, information about a publisher (e.g., publisher 104) the central theme of the source of the content items 132 (e.g., content containers 122), etc. The information about the image itself or about object(s) contained in the image may correspond to one or more objects (e.g., a tube of Crest toothpaste, a Ralph Lauren polo shirt, a silver chandelier), one or more object classes (e.g., “couches”, “vases”, “bath tubs”), concepts (e.g., “interior”, “exterior”, “nighttime”, “close-up”), types (e.g., style, manufacturer, brand identification, designer identification), features (e.g., colors, patterns, shapes), and/or other information that is sufficiently specific to enable the system to recognize the image and/or the object(s) in the image.

System 210 may perform anyone of many processes to procure image content items. In one implementation, system 210 may employ an image crawler, e.g., web crawl system 330, to crawl network 110 to locate web files or other files, including files that contain images, for procurement of web image content items 311 from third party web sites. Generally, any type of web image content items 311 can be collected. From the web image content items 311, procured from sources on network 110, such as third party web sites, text data 312, metadata 313 and image data 314 may be procured by system 210.

Such crawling of random or semi-random web image content items 311 may serve several goals. For example, the information, collected from web image content items 311, may be indexed and stored in one or many databases, for later retrieval. This database may be queried for similarity matches to a query image content item (e.g., query image content items 301) and should any web image content item (e.g., web image content items 311) be identified as a near copy of the query image content item, the information stored on the web image content item may be transferred to the information, retrieved from the query image content item. Consequently, an automatic enrichment of the information, extracted from the query image content item, may be achieved.

As another example, the visual information on a web image content item (e.g., web image content items 311), such as extracted global and/or local feature vector information, may, should the web image content item be identified as a near copy of a query image content item (e.g., query image content items 301), be transferred to that query image content item. Consequently, a significant improvement of the extraction speed and a reduction of the computational expensiveness may be achieved.

Detailed descriptions on these and other exemplary applications for the web image content items will be provided in further detail below.

In some implementations, system 210 may interface with or receive feeds from a library or collection of images. For example, but without limitations, system 210 may, through automated feeds, through (manual or programmatic) uploads by merchants or other humans operators, and/or through any other provision method, receive product image content items (e.g., product image content items 321), such as product databases with product images and related data records, pertaining to e-commerce objects or merchandise, from an advertiser content repository (e.g., product data repository 111) of advertisers (e.g., advertiser 103), such as online merchants.

From the procured product image content items 321, text data 322, metadata 323 and image data 324 may be extracted. The collective data extracted may, in some exemplary embodiments of the invention, be used to act as another part of an e-commerce system that enables matching of product images, e.g., procured product content items 321, with a query image, e.g., query image content items 301, which before were enriched with the data of crawled images, e.g., web image content items 311.

Procured product images or other images (e.g., the images in product image content items 321) may, in some embodiments, be segmented using a segmenter 340. The objective of the segmenter 340 is to separate the object(s) of interest, contained in the images, from their background. In other words, the segmenter 340 may erase the background from product images, resulting in a segmented image of one or more objects on a transparent background.

For example, the segmenter 340 may manipulate product images (e.g., the images in product image content items 321) by segmenting the visual of the product, contained in the image, from its solid background. As the product images or other images may be used to populate an image collage ad (e.g., collage ad 133), and may be layered, i.e., laid over one another, to arrive at a visually pleasing collage, the solid backgrounds of any objects in the images that come on top, i.e., are positioned in the top layers, should not obstruct the visibility of the objects in the images that are underlying, i.e., are positioned in the bottom layers. Images, for example web images or images, supplied by merchants or other advertisers (e.g., advertiser 103), generally do not include transparency and therefore, these images need to be transformed into images with a transparent background for application in a collage ad (e.g., collage ad 133).

Segmenter 340 may utilize any of many foreground/background segmentation algorithms and/or trimap algorithms available. For example, but without limitations, masking and edge detection algorithms, variations of chroma key compositing, alpha matte and/or a learnt set of a mixture of Gaussian models may be employed for programmatic segmentation, individually, collectively or consecutively. In other embodiments, pixels along the edge of an image may be sampled to identify the background. The dominant color found may be identified as the background color and set to transparent, to arrive at an image with a transparent background. Other segmentation algorithms may also be used.

One or more embodiments provide that segmenter 340 receives or uses hints or a priori knowledge, when segmenting a product image from its background. Alternatively, a multi-step procedure may be used, consisting of one or several segmentation algorithms that rely on prior manual input for identifying the optimal segmentation, to be used posterior to a programmatic algorithm. For example, but without limitation, an operator may manually provide foreground and background seeds or provide a trimap as segmentation input, utilizing a (branch) max-flow/min-cut energy minimization, a graph cuts technique, the Grabcut algorithm, Poisson matting, Bayesian matting, a watershed algorithm, a weighted distance function (geodesic) algorithm or any other algorithm, that includes a manual input procedure.

Irrespective of the type or implementation of the segmentation algorithms chosen, one or more embodiments provide for the use of human knowledge to approve, disapprove or adjust the segmentation, resulting from the segmentation algorithms used. Embodiments recognize that programmatic or machine-based segmentation may be prone to error, resulting in less optimal segmentations than what can be provided by a human editor. Accordingly, manual input 345 provides for manual input and/or manual confirmation of the segmentation performed on the images, in determining the quality of the segmented image. In one exemplary implementation, manual confirmation may encompass displaying an overview of the segmented images to a human editor, enabling the editor to accept or reject the segmented image, using a simple binary approval function. Other embodiments provide for the use of human editors to actively identify the appropriate next step for a segmented image, and/or to actively edit the segmentation, for example by using sliders to increase or decrease the measure of fuzziness and/or to manually influence the settings of other morphological functions.

In some implementations, system 210 may receive triggers to access other sites or network locations, for example the site of a publisher 104, to procure uploads or content item submissions from (employees of) that publisher, as soon as these uploads or submissions take place, and/or to procure image content items (e.g., query image content items 301) from uploads or submissions from users (e.g., user 101). In yet another implementation, system 210 may receive requests for procurement of image content items through real-time programmatic triggers, such as a visit of a user to a web page of a publisher.

In some implementations, manual input (e.g., manual input 305, manual input 315 and/or manual input 325) may be used to enrich image content items (e.g., query image content items 301, web image content items 311, and/or product image content items 321) procured. Such manual enrichment may take the form of human editors, using their human knowledge to manually annotate procured images (e.g., the images in query image content items 301, web image content items 311, and/or product image content items 321) with additional information about the image or the object(s), contained in the image.

The information, collected by system 210, is forwarded to an indexing system (e.g., indexer 400).

### IV. IMAGE INDEXING AND STORAGE

Referring now to FIG. 4, a storage & indexing system 220 is shown, as used under some embodiments of the invention. System 220 may determine the information about the image and/or object(s) in the image of a given image content item (e.g., query image content items 301, web image content items 311 and/or pre-processed product image content items 321), using image analysis and recognition, text analysis, metadata analysis, human input and/or enrichment, or any combination thereof.

System 220 may contain an indexer 400, which may use an image data indexer 410 to collect and index information from the actual content of non-text files (e.g., image data 304, 314 and/or 324), through the use of a recognition component, which may employ one or more of the many available recognition techniques to identify low level and high level features, such as shapes, patterns, colors, faces, local or global features and/or other visual information, contained in an image. Indexer 400 may also, under some embodiments, analyze semantic data (e.g., text data 302, 312, and/or 322), metadata (e.g., metadata 303, 313, and/or 323) and/or other data derived there from, by using text/meta data indexer 420.

The text/meta data indexer 420 may, under some embodiments, use an identification and indexing mechanism that combines a semantic phase with a traditional tag identification phase, i.e., a syntactic phase. The semantic phase may classify text data (e.g., text data 302, 312 and 322), and metadata (e.g., metadata 303, 313 and 323), as extracted from image content items (e.g., web image content items 301, query image content items 311 and/or product image content items 321), into a taxonomy of topical concepts, sub-concepts and/or concept groups, and may use proximity as a classification factor in a concept ranking algorithm. The resulting hierarchical taxonomy may allow for gradual generalization of the extracted information, should no text data and/or tags be found that are matching the precise (sub)concepts of the image content items.

For example, if a human would identify an image as being about a bathroom, but the text data and metadata extracted only contain the concepts “towel” and “bathtub”, text/meta data indexer 420 would still identify the image as being related to “bathroom”, as both of these concepts are part of the parent, or concept group, “bathroom”. Moreover, text/meta data indexer 420 would still rank the image highly for shower taps, as this sub-concept belongs to the concept “shower”, which is a sibling of the concept “bathtub”, and both of these concepts share the parent, or concept group, “bathroom”.

In some embodiments, certain sub-concepts and/or concepts may have an identifier, or “type”, assigned to them. Such identification may be advantageous in that a preferred display-mode could be set for every type identified. For example, in the previous example, the concept “towel” may have attached to it the type “accessory”. The type “accessory” may have assigned to it a dimensional display-mode, which may be smaller than the display-mode set for other types or for concepts, which do not have assigned to them the type “accessory”. Thus, should “towel” be identified in the image content items (e.g., product image content items 321), on the collage ad (e.g., collage ad 133) to be populated, such image (e.g., the image in product image content items 321) may be displayed smaller than images, that are not identified as type “accessory”.

Albeit two specific examples have been provided above, one skilled in the art will understand that many other taxonomic structures or combinations of taxonomic structures may be applied to arrive at the same or a similar outcome.

The taxonomy and associated algorithms may be laid down in a semantic tag codebook 421, contained in indexer 400. This codebook 421 may further include weights, priority setting rules and other factors for enabling programmatic identification of concepts and tags, as retrieved from image content items (e.g., web image content items 301, query image content items 311, and/or product image content items 321), and their inter-relationships. Similarly, codebook 421 may include synonyms and stems for the tags, concepts, and other semantic data contained therein.

In some embodiments, semantic tag codebook 421 may also encompass taxonomy rules that may be used to narrow down the concept identification to a larger granularity. For example, filters may be applied, that identify concepts that do not change fast, such as brands, as well as concepts that are more dynamic and granular, e.g., names of product series, which may change faster. Equally, adjectives, identifying the gist of the scene or the object, may be used as filters to arrive at more fine-grained concept identifications.

In several exemplary implementations, an adjusted Term Frequency-Inverse Document Frequency (TF-IDF) algorithm may be applied to calculate TF-IDF information of individual tags, which subsequently may be stored with that specific tag. Such numerical statistic may indicate how important the tag is, and how descriptive. For example, should a tag be identified that is relatively rare in the whole collection of tags extracted, it may be considered more important for similarity matching.

As an alternative or addition, one or more embodiments may utilize machine learning techniques when applying concept determination and classification. In one embodiment, ground truth data may be collected that has objects or scenes in images annotated with the concepts or concept groups for those objects or scenes. Machine Learning techniques like logistic regression, naive Bayes, and support vector machines (SVM) may be used to learn a classification model for concept (group) mapping. Such classification model may be learned separately over each concept or concept group, or over a set of concepts or concept groups.

In yet another embodiment, a Histogram of Textual Concepts (HTC) may be used to create a histogram, based on a vocabulary or dictionary of concepts and their underlying relationships, such as the semantic tag codebook 421, described above. Each bin of such histogram may represent a concept of the codebook 421, whereas its value is the accumulation of the contribution of each tag within the text data (e.g., text data 302, 312, and/or 322) procured, and/or the metadata (e.g., metadata 303, 313, and/or 323) procured toward the underlying concept, according to a predefined semantic similarity measure. This approach is able to identify the semantic relatedness of the text data and/or meta data over a set of semantic concepts defined in the codebook 421, even for sparsely annotated images. Additionally, in case of polysemy, a HTC may help disambiguate textual concepts according to the context, and in case of synonyms, a HTC may reinforce the concept related to the synonym, in a similar manner as the approach, described above. In some embodiments, the HTC may be enhanced by combining it with TF-IDF features.

Further, in some embodiments, one or several preprocessing steps may be included in the taxonomy algorithm, for example, to remove the stopping tags or to stem the tags extracted for different languages. Yet further, in some embodiments, pre-existing toolkits such as the Lemur Toolkit, Indri or the WordNet lexical database, with or without a TF-IDF retrieval model, and with or without one of the many available stemming toolkits, may be employed.

Yet further, in some embodiments, weighting 435 may be applied to the concepts indexed. For example, weighting 435 may be applied on the concepts, indexed from image content items (e.g., web image content items 301), to promote the information, provided by the presumed source (i.e., the content items with the oldest date/time stamp). Alternatively, weighting 435 may be applied on the concepts, indexed from image content items (e.g., product image content items 321), to promote the information, provided by the vendor of a product. As a last example, weighting may be applied based upon the source of the image content item (e.g., text data 302, 312, and/or 322) found, to promote more important sources (e.g., a title) over other sources (e.g., a body text). Many other weighting applications may be used.

One or more implementations, including the implementations discussed above, may use manual input 436, in the form of human operators to generate reference lists of tags, i.e., words and/or phrases, and organize them into a taxonomy of sub-concepts, concepts, concept groups, identifiers and filters, as contained in the semantic tag codebook 421. These human operators may also be used to assign weights and priority setting rules to the reference lists generated. Such assignment may be based on an understanding, developed by the human operator as to the vocabulary used by the demographic that is associated with a particular concept, sub-concept or concept group. Many other assignment rules may be applied. The weights may reflect the meaning or importance of individual tags, and as such, may be provided by human operators who are familiar with trends in how vocabulary is used over time.

Due to the diversity of knowledge and cultural background of humans, semantic data, such as text data (e.g., text data 302, 312, and 322) and metadata (e.g., metadata 303, 313, and 323) may be subjective and inaccurate, in the sense that it may not accurately and objectively describe aspects of the visual content of an image and therefore may not reflect visual concepts such as objects, scenes, and events contained in the image well. Even when taxonomic tag structuring algorithms (e.g., the semantic tag codebook 421) and tag statistics such as TF-IDF are used, tag relevance might be poor. Therefore, some embodiments provide that indexer 400 contains an image data indexer 410 to index non-textual image data (e.g., image data 304, 314 and 324) from content items (e.g., query image content items 301, web image content items 311, and product image content items 321), next to or instead of text data and metadata.

Such image data identification and indexing may serve several goals. For example, but without limitations, in some embodiments, image data comparison may assist in detecting images that are exact copies or near copies of content items (e.g., images in query image content items 301, web image content items 311, and/or product image content items 321), for example stored in one or more image databases (e.g., image databases 440). Should one or more exact or near duplicates be found in image databases 440, the text data (e.g., text data 301, and/or text data 311), and the metadata (e.g., metadata 302, and/or metadata 312) of the (near) duplicates found may be transferred to the query image content items 301, to enrich the information, available on these content items. Additionally, image data (e.g., image data 303, and/or image data 313) may be transferred, to enable a less computationally expensive and time-consuming extraction and indexing process for the query image content items.

Some exemplary embodiments may utilize image data comparison to assist in visually identifying one or more concepts or sub-concepts in the images. For example, comparison of image data 324 of product image content items 321 with image data 304 of query image content items 301 may enable the selection of product images (e.g., the images in product image content items 321) that are conceptually close to the image queried (e.g., the images in query image content items 301), for inclusion in a collage ad (e.g. collage ad 133).

Yet other embodiments may use image data comparison to learn the relevance of textual data extracted from an image. For example, a tag found in the content items (e.g., web image content items 311) may be inferred to other content items (e.g., query image content items 301), should the image in the first content items (e.g., the image in web image content items 311) be a visual neighbor of the image in the second content items (e.g., the image in query image content items 301).

Typically, non-textual image identification involves extracting an identifier that in some way captures the features of the image to be identified. Such an image identifier needs to be robust to common image modifications, such as cropping, scaling, re-coloring, rotation, and affine transformations. Additionally, given the potentially unlimited array of images to be queried and concepts to be extracted from these query images within the current invention, ideally, an unsupervised and lightweight programmatic method for image identification should be used, allowing for extremely fast search and retrieval. Therefore, some embodiments may refrain from using feature extraction, but may use alternative image identification techniques. Other embodiments may use only one single feature or one single type of feature to be extracted. However, as no single feature can represent the image content completely, e.g., global features are suitable for capturing the gist of the scene of an image, whereas local features are better for recognizing objects, contained in the image, under yet other embodiments of the invention, images may be represented by multiple types of features, using multiple—speeded up—identifier extraction procedures.

For example, a combination of global and local features may be used. Global features are capable of generalizing an entire image with a single vector, describing color, texture, or shape, and are not very computationally expensive. Local features are much more computationally expensive, as this type of features is computed at multiple points of interest on an image. For example, following a multi-feature approach, global feature descriptors such as GIST, Profile Entropy Features (textures), Color64, Color Moments (colors) and/or Compact Composite Descriptors (CCDs, such as the Joint Composite Descriptor (JCD), and the Spatial Color Distribution (SpCD) descriptor) may be used, next to or together with local feature descriptors such as (an optimized, adjusted or altered version of) Scale-Invariant Feature Transform (SIFT), Gradient Location and Orientation Histogram (GLOH), and Speeded-Up Robust Features (SURF), and/or any other or combination of other local feature descriptors.

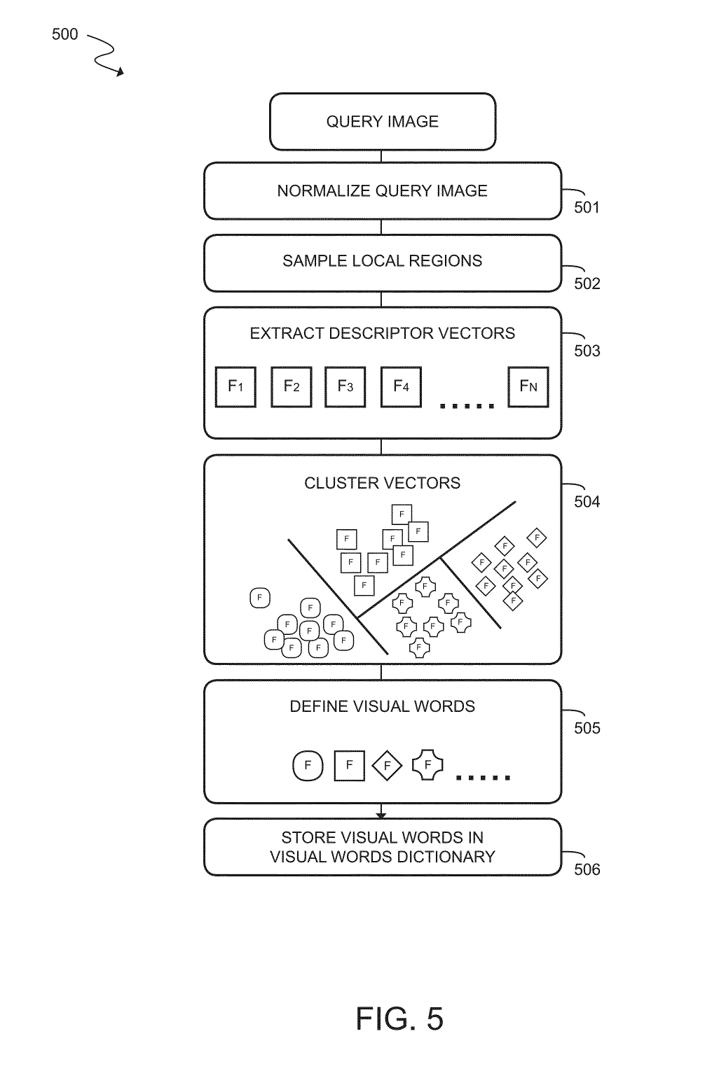

For the local feature representation, in these or other embodiments, a Bag-Of-Visual-Words (BOVW) model may be used, as the BOVW paradigm has become a popular image representation technique for Content-Based Image Retrieval (CBIR), mainly because of its good retrieval effectiveness. BOVW is a representation of images that is built using a large set of local features, for example, the features mentioned above. The paradigm is inspired on the bag-of-words models in text retrieval, where a document is represented by a set of distinct keywords. Analogously, in BOVW models, an image is represented by a set of distinct visual words, derived from local features. To enable this, each image is abstracted by several local patches (i.e., local features). These patches are represented as numerical vectors, which are called feature descriptors. Then, the patches, which are represented by vectors, are converted to “code words”, to be stored in a “codebook” (analogous to a dictionary for written language). See also FIG. 5, which will be described in further detail below.

Some embodiments may use the TopSURF descriptor, as this is a state-of-the-art implementation of BOVW, suitable for a wide range of CBIR applications. TopSURF is a visual library that combines interest points with visual words, resulting in a high performance compact descriptor. The TopSURF descriptor initially extracts SURF local features from images and then groups them into a desired number of clusters. Each cluster can be seen as a visual word. All visual words are stored in a visual dictionary. Next, TF-IDF weighting is applied in order to assign a score to all the visual words. Contrary to many other BOVW models, the TopSURF image descriptor is created by choosing a limited number of top-scoring visual words in the image. Thus, the TopSURF descriptor improves the time complexity and quality of the overall process exponentially. In real-life experiments, TopSURF has proven to be able to extract the descriptor and match it to the codebook of visual words in less than a second per image, featuring a relatively good Mean Average Precision (MAP), while resulting in an easy to use numerical match percentage, and therefore, some exemplary embodiments propose to employ TopSURF. Yet, any other elegant, robust, and fast local feature descriptor may be used within the scope of the invention.

FIG. 5 is a block diagram of an exemplary method 500 for finding image data matches (e.g., matches between image data 304, 314, and/or 324) to suit any of the goals described above. Initially, an input image (e.g., the image in query image content items 301, web image content items 311, and/or product image content items 321) may be normalized to a standard size (e.g., 400 pixels by 400 pixels) (501). For this, any conventional down-sampling and/or interpolation technique may be used. Alternate implementations utilize any of a variety of other kinds of normalization, e.g., color balance, contrast, intensity, etc., in addition to, or instead of, size normalization. Yet other implementations omit normalization altogether.

Small image regions are then sampled (502) and associated interest points (i.e., descriptors) are extracted (503) from the normalized image. These descriptor vectors are then clustered (504), using any clustering algorithm available. The resulting cluster centers may then be used to define visual words (505) in a nearest neighbor sense by partitioning the descriptor space. Each resulting partition represents a visual word. The visual words may be stored (506) in a visual words dictionary (e.g., visual tag codebook 411). Such dictionary may be learned from a training set, e.g., collected by a web crawler (e.g., web crawler 330).

By (further) reducing the original descriptor size, the computational cost may be significantly lowered. Therefore, in some embodiments, to arrive at a visual tag codebook 411, on each cluster, indexed by a cluster center, Principal Component Analysis or any other reduction algorithm may be employed. Subsequently, for image similarity search between image data (e.g., image data 304, 314, and/or 324) neighbor search may be conducted, based on the reduced feature, within the subsets whose centers are closest to the query. Such exemplary approach harnesses the high-level qualities of interest points (i.e., features), while significantly reducing the memory needed to represent and compare images.

In some other embodiments, the co-occurrence of particular visual words within an image may be analyzed and visual words may be combined into “visual phrases” in the visual words dictionary (e.g., visual tag codebook 411), opening up possibilities for improved matching of objects and images.

In yet other embodiments, different alternative solutions to add relationships and hierarchy amongst the visual words in the visual words dictionary (e.g., visual tag codebook 411) may be employed. For example, a vocabulary tree may be used, defining a hierarchical quantization that is built by hierarchical k-means clustering, wherein k may define the branch factor (i.e., the number of children of each node) of the tree. The tree may be determined level by level, up to some maximum number of levels L, and each division into k parts may only be defined by the distribution of the descriptor vectors, belonging to the parent quantization cell. Thus, each descriptor vector may be propagated down the tree by, at each level, comparing the descriptor vector to the k candidate cluster centers (represented by k children in the tree) and choosing the closest one (or ones).

In yet other implementations, a preliminary segmentation algorithm may be executed on an image, before feature extraction. For example, a masking, (branch) min-cut or watershed algorithm may be used on the query image (e.g., the image in query image content items 301, web image content items 311, and/or product image content items 321), and the resulting regions of this segmentation may be used as the small image regions to be sampled for interest point detection.

Finally, some embodiments may use a geometric 3D model-based approach, in which (statistical) features are extracted from a number of pre-captured and/or pre-calculated and/or pre-rendered fixed views of an object to be recognized. In the recognition process, the (3D) spatial orientation of the extracted features may be matched to the features, detected in query images (e.g., the images in query image content items 301, and/or web image content items 311). Thus, geometric constraints, such as pose variations, may be overcome.

Whichever of the aforementioned approaches is taken, some embodiments recognize that, although the BOVW model is highly popular and state-of-the-art, in some situations, such as the identification of objects in an image for matching product images (e.g., the images in product content items 321) with similar objects in query images (e.g., the images in query image content items 301, and/or web image content items 311), the visual information may not be enough to provide a semantic interpretation of an image. Therefore, in these exemplary embodiments, both tag similarity and image similarity may be combined, to arrive at a combined retrieval paradigm, in a joint-modality approach. For example, a two-stage image retrieval procedure may be utilized, to infer the relevance of a textual tag with respect to an image from the tags of its visual neighbors. Thus, first an image modality may be used to rank the image retrieved (e.g., an image in query image content items 301, and/or web image content items 311) on visual similarity, before a text modality is employed, ranking the image on the concepts, contained in the dictionary (e.g., semantic tag codebook 321). The latter ranking may use weighting, derived from the results from the first step (i.e., the image modality). In another embodiment, the taxonomic ranking algorithm may be executed on the top-K items only, as identified in the image recognition modality. The reverse may also be employed, in some embodiments; first a text modality may be used to rank the query image on the concepts, contained in the dictionary (e.g., semantic tag codebook 321), and then image recognition procedures may be executed on the top-K items only, as identified in the text modality. Alternatively, a method of searching the modalities separately and fusing their results may be employed, in some alternative embodiments. In order to combine the textual and visual features efficiently, some implementations may use a Selective Weighted Late Fusion (SWLF) scheme, which learns to automatically select and weight the best features for each visual concept to be recognized. However, any other algorithms for combining the derived textual and visual features may be employed, as one skilled in the art will understand.

Referring back to FIG. 4, in some embodiments, from the calculated feature vectors, one or more hashes of data vectors may be calculated, consisting of or including the identified descriptor vectors, by a hash extractor module (e.g., hash extractor 430). A hash refers to a characteristic data string (preferably, for the purpose of the current invention, a bit vector) generated from a larger data vector, e.g., a descriptor vector. An important property of the used hash function, i.e., the function that generates the hashes in a programmatic and systematic way from the input vectors, is that the Hamming distance between two hashes indicates the level of similarity between the original vectors.

For the calculation of a binary, decimal or hexadecimal hash from the feature vectors, one or several of the various available techniques may be used. For example, but without limitations, the query image's hash value may be calculated by using the mean value of the image vector. Then, for values above this mean value, the image vector is assigned a value of 1, and for values below this mean value the image vector is assigned a value of 0. This transforms the K-dimensional image vector into a K-bit binary string, which becomes the query images hash code. As another example, the (adapted) TF-IDF scores of the visual words may be used as their hash code, for quick retrieval.

In another implementation, cryptographic hash functions, such as MD5, SHA1, SHA2 or any other cryptographic hash function, may be employed to calculate a hash for each image. For example, hash extractor 430 may calculate a cryptographic hash for the images (e.g., the images in query image content items 301, web image content items 311, and/or web image content items 321), which may be stored with that image in a database (e.g., image databases 440 and/or product databases 450). Such approach may be used as a first step in quick retrieval of duplicate images in the image databases (e.g., image databases 440). As another example, some form of perceptual hash may be calculated, e.g., using a discrete cosine transform (DCT) to reduce the frequencies, before extracting the hash. Perceptual hashes are more robust against changes in scale, aspect ratios and color (such as contrast or brightness) and are thus able to retrieve duplicates and near-duplicates in a fast and reliable way. Therefore, in some embodiments, a perceptual hash calculation may be used, as a first retrieval attempt in a multi-modal retrieval procedure. In yet another example, the image (e.g., the images in query image content items 301, web image content items 311, and/or web image content items 321) may first be segmented by hash extractor 430, followed by computing some form of perceptual hash of the segmented sub-regions. In a last illustrative example, the hash values, computed following any of the procedures mentioned above or in any other hash extraction procedure, employed by hash extractor 430, may be further reduced into simple derivatives, enabling a cascaded or tree-based search structure for the database(s) (e.g., image databases 440), thus speeding up the retrieval procedure. Instead of or next to the before-mentioned examples, many other hash or hash-based functions for speeded-up retrieval may be used.

Information on features, collected by image data indexer 410, together with information on semantic tags, collected by text/meta data indexer 420, and the hash values, extracted by hash extractor 430, may be stored in one of many image databases 440, one of many product databases 450 and/or may be provided as input to image similarity matching system 230.

Referring now to FIG. 6a, a block diagram of an exemplary method to procure, index and store web image content items 311 is shown.

The information on the third party images and the object(s) contained in these images, as procured by a web crawler (e.g., web crawl system 330) (601), extracted (602), and indexed by indexer 400 (603), are stored in one or more image databases 440 (604), together with source data, for propagation of additional information to the procured query image content items 301, utilizing any of the many similarity matching algorithms available, as will be described in further detail below.

Referring now to FIG. 6b, a diagram of an exemplary method for the procurement, indexing and storage of product image content items 321 is shown.

After the procurement of the product image content items 321 from a publisher (e.g., publisher 104), a user (e.g., user 101), and/or any other source (605), the pre-processing of the image (e.g., the image in product image content items 321) by segmenter 340 (606), the data extraction (607), and the indexing by indexer 400 (608) of product content items 321, the segmented image, together with the extracted and indexed product content items 321 and/or any other information, as described above, may be stored in one of many product databases 450 (609), for later retrieval by the image similarity matching system 230.

In one or more embodiments, when information about images of merchandise objects is stored in one or several product databases 450, the information may include URLs or other links to online merchants that provide the merchandise objects for sale. Such link may enable dynamic data procurement and updating.

Each of the extracted and indexed features may be stored numerically as vectors, as textual data or as binary, decimal and/or hexadecimal strings. TF-IDF information of the semantic tags and/or the visual words may also be saved, together with the extracted and indexed semantic and/or visual data, as well as location-specific and/or source-specific information, with respect to the extracted and indexed visual data. In several embodiments, many other recognition information data may be stored in databases (e.g., image databases 440 and/or product databases 450).

In one embodiment, a linear index may be used where each item is stored linearly in a file. In another embodiment, a tree based indexing algorithm may be used, where the nodes of the tree would keep clusters of similar items. This way, only that node needs to be loaded in the search time, and the search may be performed faster.

### IV IMAGE SIMILARITY MATCHING

Referring now to FIG. 6c, an exemplary diagram of the procurement, indexing, optional storage, matching and selection method for query image content items 301 is shown.

After receiving a request for a collage ad (e.g., collage ad 133), to be provided for a query image (e.g., query image content items 301) (610), image procurement & pre-process system 210 may try to extract as much information as possible from the data procured (e.g., image data 302, text data 303, and metadata 304) for the query image (611). In some embodiments, the semantic data (e.g., text data 302 and metadata 303) may be indexed (612) and temporarily stored.

Then, the indexer 400 may extract a hash value (613), e.g. a cryptographic and/or perceptual hash, for quick comparison with image databases 440 (614) to find near-duplicate images (e.g., images in web image content items 311) in the database.

In some embodiments, hash extraction and comparison with images in the databases (e.g., web image content items 311 in image databases 440) may only be employed, if certain thresholds are not met. For example, comparison may only be employed, should the extraction in step 611 not result in detailed semantic information. Should this information exceed the threshold set, a speeded up procedure may be employed (615). Any form or type of threshold may be identified.

In other embodiments, hash extraction and comparison with images in the databases (e.g., web image content items 311 in image databases 440) may always be employed, independent from any threshold. In yet other embodiments, the comparison with images in the databases (e.g., web image content items 311 in image databases 440) may be omitted altogether.

In several embodiments, should the comparison (616) of the hash value, extracted from the image (e.g., the image in query image content items 301), with the hash values from the images (e.g., the images in web image content items 311) stored in the databases (e.g., image databases 440), return no matching results, visual descriptors such as described above, e.g. TopSURF descriptors, or any other feature descriptors, or their derived hash values, may be calculated from the query image (e.g., the image in query image content items 301) (617), and employed to query the image databases 440 for exact copies or near copies of the query image (618).

Should the comparison of the visual descriptor values or their derived hash values, as extracted from the image (e.g., the image in query image content items 301) and indexed, with the visual descriptor values or their derived hash values from the images (e.g., the images in web image content items 311) stored in the databases (e.g., image databases 440), return no matching results (619), weighting may be applied (620) on the indexed data (e.g., text data 302, metadata 303, and image data 304), after which the indexed data may be compared to template databases (621) and matching templates may be selected (622), in some embodiments of the invention. Concurrently, the indexed data may be compared on similarity to one or more product databases (e.g., product databases 450) (623), and matching products may be identified and selected (624). This matching may be employed by image similarity matching system 230, which is described in further detail below.

Should one or more exact or near duplicates be found in the image databases (e.g., image databases 440), when comparing the hash value, derived from the query image (e.g., query image content items 301) (616), the image data (e.g., image data 314) from the matching images (e.g., web image content items 311) may be collected from storage (e.g., image databases 440) (625). The collected data may then be propagated to the query image (626). Semantic data (e.g., text data 312 and/or metadata 313) may then be collected from the matching images (e.g., web image content items 311) in storage (e.g., image databases 440) (627), and propagated to the query image (628), in some implementations of the invention.

Should one or more exact or near duplicates be found in the image databases (e.g., image databases 440), when comparing the visual descriptor values or their hash value, derived from the query image (e.g., query image content items 301) (619), the semantic data (e.g., text data 312 and/or metadata 313) from the matching images (e.g., web image content items 311) may be collected from storage (e.g., image databases 440) (627), and propagated to the query image (628), under some implementations of the invention.

In some embodiments, the extracted and indexed data (e.g., text data 302, metadata 303, and image data 304) from the query image (e.g., query image content items 301) may be stored in one or more image databases (e.g., image databases 440) (629). In these or other embodiments, also the ad components, selected for inclusion in the collage ad, or the collage ad or collage ads, composed for the query image, may be stored in image databases 440. Should additional ad requests (610) for that particular query image be received, the stored information on that image may be retrieved from the databases (e.g., image databases 440), enabling a speeded-up extraction and indexing procedure. Any other storage and other functions, enabling a faster, more efficient or more effective procedure for extraction and indexing, may be added.

In FIG. 7, an exemplary image similarity matching system 230 is shown, containing an image similarity matching engine (ISME) 720, which may contain one or more modules for matching images (e.g., image matcher 721), which may match query images (e.g., query image data 701) with images and other data, contained in one or more image databases (e.g., image databases 440). ISME 720 may also contain one or more modules for matching products (e.g., product matcher 722), which may match query images (e.g., query image data 701) with images and other data, contained in one or more product databases (e.g., product databases 450), and one or more modules for matching templates (e.g., template matcher 723), which may match query images (e.g., query image data 701) with different types of templates, contained in one or more template databases (e.g., template databases 710), under some implementations of the invention.

The ISME 720 may, in some implementations, use indexed data (e.g., query image data 701) as an input and may match this data against stored data (e.g., the data in image databases 440), to enable the propagation of stored data (e.g., text data 312, metadata 313, and/or image data 314 from web image content items 311, and/or text data 302, metadata 303, and/or image data 304 from previously stored query image content items 301) to the query image (e.g., text data 302, metadata 303, and/or image data 304 from query image content items 301), and thus enable the enrichment of the query image data, as described before. Such similarity matching may be employed by using any of the many similarity matching algorithms available.

When enough interest points in the query image (e.g., the image in query image content items 301) match those in any image in the image databases 440 or the product databases 450, the images are likely to depict the same scene or concept or may contain the same object(s), and thus, may be identified as (near) duplicates or as sharing the same or similar objects, concepts or sub-concepts. To determine these matches, a nearest neighbor ratio matching technique, such as, for example, nearest neighbor search, nearest neighbor voting, or any variant thereof, may be used, in which each interest point in the query image is compared to all interest points in the image in the image databases 440 and/or the product databases 450 by calculating the Euclidean distance between their descriptors. A visual words dictionary (e.g., visual tag codebook 411) may be employed to assist the algorithm used.

As another example, some form of Hamming distance calculation on the hash values, extracted from the image data (e.g., query image data 304) or derived from the visual descriptors stored may be used.

As yet another non-limiting example, the normalized cosine similarity may be used to measure the distance between the TF-IDF histograms of the descriptors, e.g., the TopSURF descriptors or any other visual descriptors or combinations thereof, of two given images, to enable near-copy detection and/or image similarity detection amongst the images (e.g., image data 304 from query image content items 301, and image data 314 from web image content items 311). Many alternative approaches or combinations of approaches for similarity matching and/or (near) copy detection may be used.

For similarity matching of the semantic data (e.g., text data 302, 312, and/or 322 and metadata 303, 313, and/or 323), several different distance weighting techniques may be used. For example, a form of TF-IDF weighting may be used. Such techniques may employ a taxonomic dictionary (e.g., semantic tag codebook 421), in some exemplary embodiments. To test the relevance of the extracted and indexed semantic concepts, sub-concepts and/or concept groups from content items (e.g., query image content items 301, web image content items 311, and/or product image content items 321), a neighbor voting algorithm may be employed to infer the relevance of the concepts found from its visual neighbors. For example, if many visually similar images, i.e., visual neighbors, are labeled with a specific tag and/or concept, found in the query image, this particular tag and/or concept is deemed highly relevant for the query image. Thus, the higher the number of visual neighbors that share a particular tag and/or concept, the higher the tag relevance value. High-frequency tags and/or concepts, i.e., tags and/or concepts that appear often in the full set of images, may at the same time be penalized for their high prior.

The tags with the highest relevance value may then be matched on similarity to one or many product databases (e.g., product databases 450), containing the segmented product images and their associated data (e.g., text data 322, metadata 323 and/or image data 324). Such matching may use a hierarchical taxonomy, that allows for the gradual generalization of the extracted information, as described above.

Such matching may also be executed using a joint-modality method based on a neighbor voting algorithm. Next to the tag relevance determination, the Euclidian distance between visual descriptors of the query image (i.e., image data 304) and the product image (i.e., image data 324) may be calculated, employing, for example, a parallel K-means clustering strategy. For example, in this type of clustering, a match is found between points in the aforementioned images if the distance between them is closer than a pre-set threshold times the distance when any other point in the images is considered.

Alternatively, in the embodiments where the visual descriptors are converted into binary hashes, a Hamming distance calculation or any other distance calculation may be employed to arrive at the matching of product images (e.g., product image content items 321) and query images (e.g., query image content items 301).

One skilled in the art will understand that many other semantic matching, visual matching and joint-modality matching algorithms are available to the inventor and may be used to execute the task of quickly and reliably determining similarity.

Simultaneously, the ISME 720 may, by employing a template matcher (e.g., template matcher 723), search for and select matching templates, under some embodiments. Template matcher 723 may select one or more pre-produced and/or dynamically composed templates and template elements from one or more template databases (e.g., template databases 710), matching the query image (e.g., query image data 701). The similarity matching techniques employed for template matching may be one or a combination of the aforementioned techniques, or any alternative or combination of alternative techniques.

For example, template matcher 723 may employ topic and/or color as similarity identifiers; should the query image (e.g., query image data 701) include one or more dominant colors, a CIE delta E calculation, color moments or other low-level feature algorithm may be employed to find and select matching templates and/or template elements. Alternatively or additionally, semantic concept group matching may be employed to find and select matching templates and/or template elements. The algorithms described may provide for a fast yet reliable matching procedure, however, other techniques or a combination of other techniques may also be employed.

In some implementations, weighting 724 may be employed on the results from the matching elements (e.g., image matcher 721, product matcher 722, and template matcher 723). Manual input 745 may be employed to assist in or optimize the programmatic selections made by ISME 720.

The subset of product databases 450 (e.g., products 730), selected for inclusion in the following steps of the method, and/or the subset of template databases 710 (e.g., templates 740), selected by ISME 720, may be provided to a collage system (e.g., collage system 240).

### V. COLLAGE COMPOSITION

FIG. 8 illustrates an exemplary collage system 240, for programmatically composing a visually appealing collage ad (e.g., collage ad 133) from a plurality of input images (e.g., products 730 and/or templates 740) and, under some embodiments, additional information.

System 240 may handle a variety of challenges. For example, system 240 may be involved with the layering of objects in a visually pleasing way, whilst at the same time preventing inappropriate relative sizing, inappropriate positioning, less-than-optimal combination and/or repetition of product images and inappropriate combination and/or non-optimal positioning of templates and/or template elements. In addition, system 240 may need to prevent the images (e.g., products 730 and/or templates 740) to be arranged in an inefficient manner so that the resulting visual summary is not as complete and pleasant to the eye as it might have been. Additionally, computational complexity may need to be taken into account by system 240, in that the amount of time spent to form collages of input images and/or additional information automatically is reduced where possible. Finally, system 240 may be faced with the subjective notion that “throwing” images together on a display area alone may not result in a collage, pleasant to the eye; some aesthetic rules may need to be taken into account to give the resulting collage an attractive look and feel.

System 240 may consist of a component (e.g., mapping system 810) for the mapping of input images (e.g., products 730 and/or templates 740 and/or additional information) following a set of mapping rules, and a component for composing a collage (e.g., collage composer 820) from the input images.

Mapping system 810 may take as its input a plurality of pre-processed product images 730, matched and selected by image similarity matching system 230. These images may be of different sizes and ratios. In some embodiments, system 810 may also take as its input one or more templates and/or template elements 740, matched and selected by image similarity matching system 230. Templates 740 may contain several types of templates, template elements, template structures and template specifications. For example, templates 740 may contain ornamental templates and ornamental template elements, which may be associated with image positioning templates, or placeholder templates. Placeholder templates may, in turn, be associated with a set of image selection criteria and a set of image positioning rules.

Templates 740 may be constructed offline by one or more user experience designers. They may contain a designer's choices of the number, sizes, and positions of image elements or ornamental elements that produce a desired aesthetic effect.

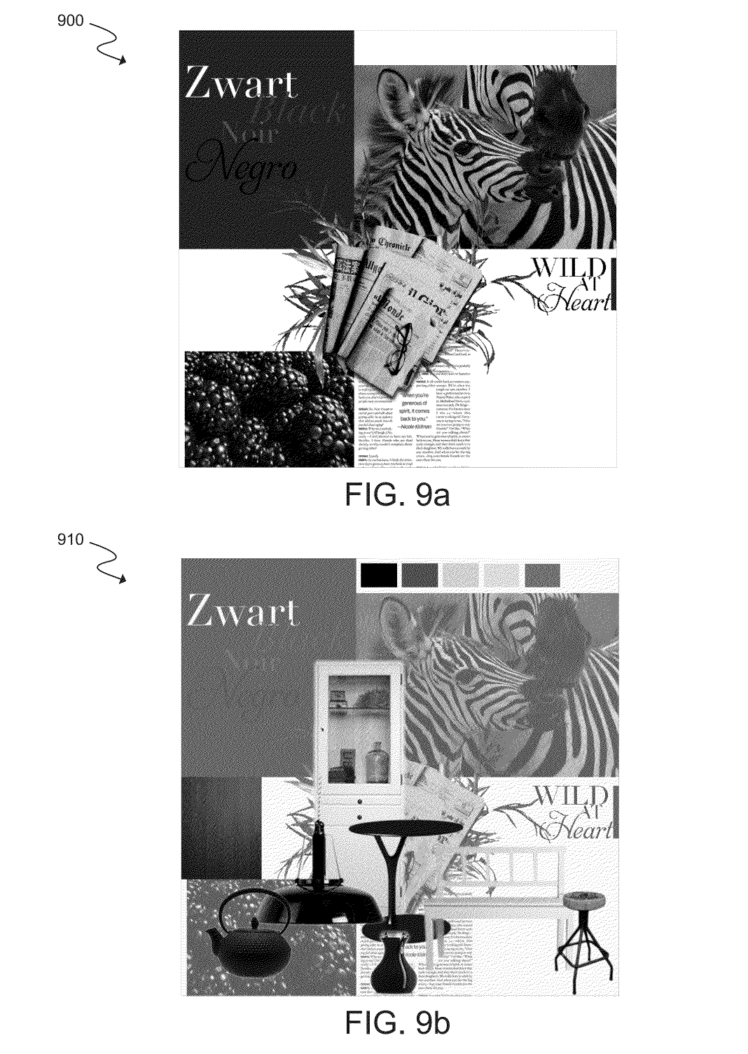

FIG. 9a contains an actual example of an ornamental template, as used in the current set-up of an exemplary embodiment of the invention. The ornamental layers, shown in FIG. 9a, are created according to a style, using inspirational imagery, coloring and typography. Although FIG. 9a shows one image of one ornamental template, one skilled in the art will understand that an ornamental template may in fact be composed out of several ornamental layers, each with a different z-index, which may result in ornamental layers under-laying as well as overlaying the later to be added product images (e.g., products 730). On paper, these layers may seem to encompass one single image, hence the “flat” representation, as displayed in FIG. 9a.

In some embodiments, ornamental templates may be dynamically composed of several elements. Thus, the ornamental template may be programmatically created from elements, stored in template databases (e.g., template databases 710). For example, ornamental template layers may be compiled of decorative images, stored in one or more decorative template images databases, decorative elements, stored in one or more decorative template elements databases, and/or decorative texts, stored in one or more decorative template texts databases, all part of the full set of template databases 710.

Decorative template images databases may contain the original query image (e.g., the image in query image content items 301) for reproduction in one of the ornamental template layers. Many other types of ornamental templates and/or ornamental template elements may be used, as well as many other ways of composing these ornamental templates and/or template elements. Common denominator of the ornamental templates and/or ornamental template layers to be employed in implementations of the invention is that templates are built (upfront or real-time) following certain design rules, well-known to design professionals and employed consciously and sub-consciously by these design professionals, such as print design professionals, to construct a well-positioned collage, pleasing to the human eye. In some embodiments however, the use of ornamental templates and/or template elements may be omitted altogether.

In several implementations, ornamental templates and ornamental template elements may be associated with placeholder templates (i.e., image positioning templates). These placeholder templates may identify layouts of regions, or placeholders, in a display area, for positioning the input images (e.g., products 730).

In one implementation, placeholder templates consist of single structural templates, identifying fixed positions for the input images in the display area. In other implementations, placeholder templates may be setting a boundary for the display area, within which the placeholders may be dynamically composed. For example, placeholders within placeholder templates may be composed according to the information (e.g., (sub)concepts, dominant colors, shapes, textures, etc.), associated with the ad components (e.g., products 730). As such, one or more colors, contained in the ad components, may determine the relative position of these components in the display area, using any of many color positioning algorithms. For example, components with similar colors may be positioned closely together, and/or components with darker colors may be positioned to the bottom and/or the background (i.e., may have a low z-index assigned to them) of the display area, whereas components with lighter colors may be positioned to the top and/or the foreground (i.e., may have a high z-index assigned to them) of the display area. Concurrently or alternatively, complex and detailed components may be identified to occupy larger areas of the display area than components with a less complex or detailed structure. As, in some embodiments, the ad components (e.g., products 730, containing images of products) may already be segmented by segmenter 340, the regions of interest (ROI) may already be clearly defined, and therefore, a visual saliency technique may be employed for identifying the complexity and level of detail of a component. For example, saliency maps may be employed, or any other technique for determining image saliency. Alternatively, an image texture technique may be employed for identifying the textural complexity of a component, e.g., Gabor filter, or any other technique for determining image texture features.

In another exemplary embodiment, placeholders in placeholder templates may be programmatically compiled by using an occlusion costing technique, e.g., by calculating a saliency map, comprised of a grey-scale map of the ad component, in which high saliency areas may be assigned a high value and/or a white pixel tone, whereas low saliency areas may be assigned a low value and/or a black pixel tone. Summing the resulting saliency levels and dividing them by the total saliency of the component will result in an occlusion costing rating, which may in turn be employed for calculating the optimal positioning of the different ad components (i.e., with an occlusion cost, close to 0), within the boundary, set by the placeholder template.

One skilled in the art will understand that many other techniques can be employed for programmatically positioning the ad components in the display area, utilizing the image data, text data and/or metadata (e.g., image data 324, text data 322 and/or metadata 323) of the ad components (e.g., products 730) to calculate an optimal positioning within the display area.

In some embodiments, each of the placeholders in a placeholder template may be assigned a template specification, which may consist of a set of one or more image selection criteria and/or a set of one or more image positioning criteria. For example, the designer, who created the ornamental templates, may have assigned such template specifications, encompassing labeling of the placeholders to indicate preferred and required placements of the ad components (e.g., products 730).

Template specifications may encompass any type of rule or criterion for selecting and/or positioning the ad components (e.g., products 730) in the display area. For example, placeholders may have been assigned a predetermined ratio. A ratio mapping system (e.g., part of placeholder mapper 811) may employ metadata (e.g., metadata 323), associated with the ad components to identify a size-wise optimal fit of a component in a placeholder. Placeholders may, as another example, be assigned a size, and placeholder mapper 811 may assign the best matching ad components (e.g., products 730), as identified by ISME 720, to the largest placeholders. Many more examples are possible. Additionally, placeholders may have assigned a “placeholder type” to them, to be used by a system (e.g., type mapper 812) for mapping the placeholder with an ad component (e.g., products 730). For example, smaller placeholders that are positioned on the foreground (i.e., have a high z-index) may be labeled “accessory placeholder”, whereas larger placeholders, further to the back, may be labeled “product placeholder” and placeholders on the background (i.e., with a low z-index) may be labeled “background placeholder”, in some exemplary embodiments of the invention. Thus, ad components and/or objects that are large in real life may be shown larger in the final collage (e.g., collage 830) than objects, such as accessories, that in real life are small.

As an alternative example, placeholders may have assigned a concept group, concept or even a sub-concept to them. Thus, placeholders may be specifically organized around a central theme, indicated by the image data (e.g., image data 304), as extracted and indexed from the query image (e.g., query image content items 301). For example, should the gist of the scene of the query image indicate “women's clothing” as the central theme, the placeholder template, associated with an ornamental template fitting the scene and the color setting of the query image, may contain a placeholder for “skirt”, a placeholder for “blouse”, a placeholder for “pumps”, a placeholder for “sunglasses”, etc., all arranged and sized to follow a human rationale concerning relative sizing.

As yet another example, placeholders may also be used for the dynamic population of the display area with ornamental template elements, next to ad components, such as products 730. For such decorative placeholders, image selection criteria and image positioning criteria may, for example, identify the type and/or style of the decorative template element, or may identify positioning criteria for the decorative template elements, in relation to the best matching ad components. For example, selection and positioning criteria for decorative placeholders may prevent the placement of a black ornamental template element, should a black ad component be identified for population of the placeholder in the layer, overlaying the decorative element, but may instead guide the procedure in selecting a decorative element with a more contrasting color.

Many other image selection criteria and image positioning criteria may be used, all of which may be stored in a set of placeholder data (e.g., placeholder data 801), and may, together with the selected templates and/or template elements (e.g., templates 740), be provided to mapping system 810.

Mapping system 810 may assign a sub-set of the ad components (e.g., products 730) to each of the placeholders in one or more placeholder templates. This process typically involves assigning a respective product 730 to a respective placeholder, in accordance with the set of image selection criteria and image positioning criteria, as provided by placeholder data 801. Thus, mapping system 810 may employ placeholder mapper 811 to map the ratios and sizes of the products 730 with the placeholder data 801 concerning sizing and ratio of the placeholders. Mapping system 810 may employ type mapper 812 to map the types and/or concepts of the products 730, as extracted and indexed by extraction & matching component 130, with the placeholder data 801 concerning type of the placeholders, under some embodiments.

Although the ad components (e.g., products 730) are already pre-processed, indexed and matched by extraction & matching component 130, and thus may be able to represent the query image (e.g., query image content items 301) well, mapping system 810 may, under some embodiments of the invention, execute additional content item mapping. For example, the content items (e.g., product image content items 321) of products 730, as indexed by indexer 400, may be mapped to the templates (e.g., templates 740) for similarity matching on color, style and other information, to select the best matching combination of template and products. In an alternative embodiment, the information on products 730 may be added to the information on the query image (e.g., query image data 701), and the combination may be employed as a filter for finding the best fitting template 740 with the best fitting placeholder data 801.

In some embodiments, weighting 815 may be applied, in the form of performance data 901, user data 902, and/or publisher and advertiser data 903, supplied by advertising system 250, as will be described in further detail below.

To avoid the inclusion of products 730, which are very similar or even exactly the same, in the final collage (e.g., collage 830), any suitable indicator of the similarity of images, such as color histograms, correlation indicators or any other suitable algorithm (as described in detail before) may be used to reject ad components. In this way the duplication of material in the collage may be avoided, in some embodiments. In other embodiments, information about the concept groups, concepts or sub-concepts, represented in the products 730, may be employed to avoid the inclusion of products 730 in the final collage (e.g., collage 830) which are representing the same or a similar product or product group. In this way the variation of ad components in the collage and thus the attractiveness of the collage may be improved.

Mapping system 810 may output a mapping between one or more selected templates 740 and one or more selected products 740 to a collage maker (e.g., collage composer 820), in the form of a set of rendering parameter values. Each set of rendering parameter values may specify a composition of the selected products in the display area, based on a selected placeholder template and a selected ornamental template or a set of ornamental template elements, under an exemplary embodiment. The rendering parameter values, produced by the mapping system 810, fully specify the compositions of the ornamental template elements and the products in layers, to be used by collage composer 820 to render the collage 830 on the display area.

Subsequently, collage composer 820 may form a collage 830 and may provide this output to advertising system 250, for further distribution.

Irrespective of the type or implementation of the algorithms for mapping and composing a collage (e.g., collage 830), one or more embodiments provide for the use of human knowledge to approve, disapprove or adjust the collage composition, resulting from the mapping and composition algorithms used. Embodiments recognize that programmatic or machine-based collage compositing may be prone to error, resulting in less optimal collages than what can be provided by a human editor. Accordingly, manual input 825 provides for manual input and/or manual confirmation of the collage created by mapping system 810 and collage composer 820. In one exemplary implementation, manual confirmation may take the form of displaying the resulting collage to a human editor, enabling the editor to accept or reject the collage image, using a simple binary approval function. Alternatively, multiple draft collage proposals may be rendered by collage composer 820, from which the editor may choose the best (i.e., most attractive to the eye) version.

Other embodiments provide for the use of human editors to actively accept or reject products (e.g., products 730) and/or template elements (e.g., templates 740), contained in the collage, and to actively request new products or template elements for the rejected ones. Embodiments may also provide for the use of human editors to actively re-organize, resize, reposition and/or regroup products, templates and template elements, for example by using a (simplified) image editing tool to drag, drop and transform elements, contained in the collage. Machine learning techniques may be employed for continuous improvement.

Mapping system 810 and collage composer 820 may be integral or independent of one another provided that they are in communication with each other.

In some embodiments, next to placeholders for products 730, additional forms of placeholders may be included in a placeholder template. For example, color placeholders may be added, for inclusion of one or many color spots or color swatches in the collage (e.g., collage 830). Such colors may be for decorative purposes only, or may be automatically filled with images of color swatches, provided by a merchant (e.g., advertiser 103), similar to the population of placeholders with products 730. Such color swatches may, among others, consist of paint swatches, fabric colors, cosmetics colors, nail polish colors, etc. For identifying the best matching colors to be added to the one or many color placeholders, any of the previously described matching algorithms may be employed. More specifically, a relatively simple CIE delta E calculation may be employed, next to or instead of more complex color matching algorithms, to select the color swatches that best match the dominant colors in the query image (e.g., image data 304).

As another example, background placeholders may be added, for example to form a backdrop for the collage, with or without other template elements. In some embodiments, this backdrop may be set to a single color, and may cover the full background, or may consist of several placeholders, positioned over the display area in an aesthetically pleasing way. The filling of these background placeholder(s) may be derived from the dominant colors in the query image. Alternatively, a background may be selected from a background database, consisting of a set of possible textures. Such textures may be loaded from images, contained in the background database, and their repetition may be computed dynamically, to fill the one or many background placeholders. For example, images for filling the background placeholders may be product images, provided by a merchant (e.g., advertiser 103). These images may consist of, for example, images of flooring, wall coverings, fabric prints, curtains, materials, etc. The background image is chosen from one of a set of possible background images in a similar fashion as the color placeholders, described before.

Next to the examples provided above, many alternative or additional variants for placeholders may be used, as one skilled in the art will understand.

Generally, the use of templates as a basis for generating the dynamic image collage (e.g., collage 830) enables the look and feel of the displayed output (e.g., collage ad 133) to be visually attractive and to appear custom made for a particular query image. FIG. 10c shows a screenshot of such a programmatically composed collage, resulting from an actual implementation of an exemplary embodiment. The procurement, pre-processing, indexing, similarity matching, collage mapping, and composition of the collage, shown in the screenshot of FIG. 10c, were all performed programmatically in accordance with the methods described in FIG. 6a, FIG. 6b, FIG. 6c, FIG. 10a, and FIG. 10b.

FIG. 10a and FIG. 10b show a flow diagram of an exemplary image collage generation process in accordance with the invention. Referring first to FIG. 10a, ISME 720 may select ornamental templates and/or template elements 740 (1001). The selected template(s) 740 may specify a connection to one or more placeholder templates (1002), which in turn may specify the layout and image selection criteria of placeholders in a display area (1003). Mapping system 810 may assign one or several of the products 730 to the identified placeholders (1004 and 1006), taking into account image positioning criteria (e.g., size, ratio, etc.; 1004) and image selection criteria (e.g., type, concept, etc.; 1006) per placeholder and may generate a set of image layers from the image elements in accordance with the templates and other information. Should the amount of selected products per individual placeholder drop below a pre-defined threshold (1005 and 1007), under some embodiments, a new ornamental template or set of ornamental template elements 740 may be selected (1001).

Should enough products 730 be assigned to each placeholder, under some embodiments selected products may be filtered on similarity or may be filtered on sub-concepts and/or concepts, to prevent duplication or near-duplication (1008). Duplicates and/or near-duplicates may then be discarded (1009). Should the resulting amount of selected products 730 per individual placeholder drop below a pre-defined threshold (1010), under some embodiments, a new ornamental template or set of ornamental template elements 740 may be selected (1001).

Referring now to FIG. 10b, in some embodiments, additional placeholder fillings may be selected in a next step (1011 and 1012). For example, color swatches may be selected (1012) from a color swatches database, and/or background swatches may be selected (1011) from a background database, using a color matching algorithm, a texture matching algorithm, and/or any other similarity matching algorithm.

Subsequently, all sub-sets of products 730, draft assigned to placeholders in the placeholder template, may, under some embodiments, be filtered taking into account the preference settings of advertisers 103 and publishers 104 (1013). Should the amount of selected products per individual placeholder drop below a pre-defined threshold (1014), under some embodiments, the process may be ended and a signal may be sent to the advertising system 250 to provide an alternative ad (1015).

Should the amount of resulting products surpass the threshold set, in some embodiments, weighting is applied according to performance data 1101 and user data 1102 (1016 and 1017), before a product 730 may finally be assigned to a region by the mapping system 810. When the resulting amount of products per placeholder becomes too low (i.e., when a single placeholder has no product 730 assigned to it), in some embodiments, the filtering on performance data 1101 and user data 1102 may gradually be loosened (1018 and 1019), until a minimum of one product 730 per placeholder remains.

Subsequently, ornamental layers may be composed (1020) and product image layers may be produced (1021), which, together with the associated product data (1022) and the ornamental elements, may be rendered (1023) into an image collage 830. Each product image layer may define the position of one of the product images 730, assigned to one of the placeholders in the placeholder template, associated with the ornamental template and/or template elements selected, together with additional information. For example, product information, product pricing, a URL to the online product page, the name of the advertiser 103, etc. may be rendered with the collage. Collage composer 820 may utilize the layer specification provided by mapping system 810 and may produce a collage 830. This collage subsequently may be provided to advertising system 250 (1024).

### VI. COLLAGE AD SERVING

FIG. 11 is a diagram functionally illustrating an advertising system 250, which may receive the collage 830, rendered by collage composer 820, from system 240, exemplary for the invention. Advertising system 250 may include an ad serving engine 1100, which in turn may contain an ad server 1110, a statistics engine 1120, and a data processing system 1130. Ad serving engine 1100 may interface with several parties of system 100, as shown in FIG. 1. For example, ad serving engine 1100 may interface with advertisers (e.g., advertiser 103) via an advertiser admin system 1140, may interface with publishers (e.g., publisher 104) through a publisher admin system 1150, and may interface with consumers (e.g., user 101), through a consumer interface 1160, for example displayed on user device 102. Although FIG. 11 shows a particular arrangement of components constituting advertising system 250, those skilled in the art will recognize that not all components need to be arranged as shown, not all components are required, and other components may be added to, or replace, those shown. Other embodiments may omit the use of an ad system, as shown in FIG. 11, altogether.

One or more users 101 may submit requests for collage ads to the system 250, or the request may be relayed through one or more publishers 104. System 250 responds by sending collage ads to the requesting users 101 for placement on or in association with one or more of a publisher's 104 content items (e.g., web properties, mobile applications, other third party content, etc.). Example web properties may include web pages, television and radio advertising slots, ad slots in mobile applications, etc., as described on the previous pages.

Ad serving engine 1100 may contain a data processing system 1130 that may, for example, encompass one or more servers and/or embedded systems. System 1130 may store and process all sorts of information, including statistical information about performance data on collage ads (e.g., collage ad 133). For example, system 1130 may handle information about the collage ad itself, about what collage ads have been shown, how often they have been shown, what collage elements (for example, products 730) have been shown, what collage compositions (for example, combinations of products 730 and/or combinations of products 730 and template and/or ornamental elements) have been shown, how often display of the collage ad or (combinations of) collage elements has led to an action or a transaction, etc. Although data processing system 1130 is shown as one unit, one skilled in the art will recognize that multiple data processing systems 1130 may be employed for gathering, processing and storing information, used in ad serving engine 1100.

Statistics engine 1120 may contain information pertaining to the selection and performance of collage ads (e.g., collage ad 133). For example, statistics engine 1120 may log the information provided by user 101 as part of an ad request, the collage ads selected for that request, and the presentation of the collage ads by ad server 1110. In addition, statistics engine 1120 may log information about what happens with the collage ad once it has been provided to user 101. This includes information such as on what location the collage ad was provided, what the response was to the collage ad, what the effect was of the collage ad, etc. Additionally, statistics engine 1120 may store user information, such as user behavior, socio-demographic information, and other information, pertaining to collage ads and their performance. Statistics engine 1120 may interface with advertisers (e.g., advertiser 103) to display advertiser specific performance data on the products (e.g., products 730) of advertisers, shown in collage ads, and may interface with publishers (e.g., publisher 104) to display publisher specific performance data on the collage ads shown on the web pages (e.g., content containers 122) of the publisher, through the advertiser admin system 1140 and the publisher admin system 1150, respectively. Statistics engine 1120 may also provide data back to collage system 240, for example in the form of user data 1102 and performance data 1101, which will be described in further detail below.

Ad server 1110 may consist of one or more servers, responsible for delivering collage ads (e.g., collage ad 133) to users (e.g., user 101). Ad server 1110 may also be responsible for procuring data from the web pages of publishers (e.g., publishers 104) and obtaining information on users (e.g., user 101), for example for targeting the collage ads to the image shown on these pages, the color settings, type faces, and other design elements used on these pages, and/or to target collage ads on the information, available on the user requesting an collage ad, in accordance with the targeting criteria, set by an advertiser (e.g., advertiser 103), for example using advertiser admin system 1140.

Ad server 1110 may perform various other tasks, as one skilled in the art will understand.

Advertiser admin system 1140 is the component by which the advertiser 103 may enter information required for advertising campaigns and may manage these campaigns. System 1140 may also be the component through which the advertiser 103 may provide and manage products (e.g., ad components 112, containing products 730 and product image content items 321), under some embodiments of the invention. Various other functionalities may be provided to the advertiser 103 through system 1140, e.g., management of account settings, the setting of targeting data (e.g., targeting data 1141) for the campaign, and the management of any other information, necessary to optimize the campaigns. Targeting data 1141 may include user information such as demographic information about the users targeted, profile data, previous collage ads selected for a user, and general location information. In some examples, additional or updated user information can be included in requests for collage ads and added to the targeting data 1141 for purposes of processing the request. For example, applications or application categories in use by the user's device 102 may be included in such a way that collage ads matching those applications can be identified.

Targeting data 1141 may also contain preference settings with respect to certain preferred or non-preferred publishers, publisher groups or publisher content preferences. For example, targeting data 1141 may include information on specific topics, such as interior or fashion, to be targeted by the campaigns of advertiser 103. As another example, targeting data 1141 may include names of specific publishers, preferred by the advertiser 103 for displaying the advertising campaigns. Many other targeting data options may be added. In some embodiments, preference settings and other settings, provided by advertiser 103, e.g., via targeting data 1141, may be processed by ad serving engine 1100 and provided to collage system 240, as publisher and advertiser settings 1103, for filtering purposes.

Components of advertiser admin system 1140 (not shown for clarity) may, in some implementations, include a billing component, which may help perform billing-related functions. For example, this billing component may generate invoices for a particular advertiser 103 for one or many collage ad campaign(s). In addition, the billing component may be used by advertiser 103 to monitor the amount being expended for its' various campaigns. Advertiser admin system 1140 may, in some embodiments, also contain a tools component, which may provide a variety of tools designed to help the advertiser 103 create, monitor, and manage its' campaigns, through, for example, bidding or auction functionalities, optimization suggestions, self-adjustment tools, etc. Finally, advertiser admin system 1140 may, in some embodiments, encompass a statistics interface, providing the advertiser 103 with insights on the performance of its collage ad campaigns, fed by statistics engine 1120, and, in some embodiments, may provide suggestions for improvement of this performance.

Publisher admin system 1150 is the component by which the publisher 104 may enter the information required for receiving advertising campaigns on its web pages and may contain various tools for managing these settings. For example, publisher admin system 1150 may, to perform these tasks, encompass a script generator, providing a script, e.g., a HTML and/or Javascript® code, for incorporation in the web pages, mobile pages or any other content environments of publisher 104 (e.g., content containers 122). Various other functionalities may be provided to the publisher 104 through system 1150, e.g., management of account settings, the management of preference data 1151, and any other information, necessary to optimize the campaigns, shown on his content environments. For example, preference data 1151 may include blacklist functionalities, by which the publisher 104 may restrict the type of advertisers (e.g., advertiser 103), the type of products provided by these advertisers or any other type of content, to be shown in collage ads on his content environments. For example, through preference data 1151, the publisher 104 may exclude certain products (e.g., ad components 122), product groups or brands, or may even block specific advertisers by name or category from displaying in the collage ads (e.g., collage ad 133), to be displayed on his content environments.

Components of publisher admin system 1150 (not shown for clarity) may, in some embodiments, include an account settings component, for managing its account settings, and a billing component, which may help perform billing-related functions. For example, this billing component may generate credit-invoices for a particular publisher 104, providing an overview of the shared earnings for that particular publisher 104 over a specified timeframe. In addition, publisher 104 may use the billing component to monitor the amount being credited for the collage ad campaigns that ran on his various web pages or other publications.

Publisher admin system 1150 may, in some embodiments, also contain a tools component, which may provide a variety of tools designed to help the publisher 104 monitor and manage the collage ad campaigns, shown on his publications, through, for example, bidding or auction functionalities, optimization suggestions, self-adjustment tools, etc. Finally, the publisher admin system 1150 may, in some embodiments, encompass a statistics interface, providing the publisher 104 with insights on the performance of the collage ad campaigns running on its publications, fed by statistics engine 1120, and, in some embodiments, may provide suggestions for improvement of this performance. Preference and other settings, provided by publisher 104, may, under some embodiments, be processed by ad serving engine 1100 and provided to collage system 240, as publisher and advertiser settings 1103.

In some embodiments, publisher preference data 1151 may not only contain data, provided by publisher 104 through publisher admin system 1150, but may also contain general data related to the publications and content of publisher 104. For example, but without limitation, publisher preference data 1151 may also contain information about the dominant colors of the web pages of publisher 104, the font typeface or typefaces used on the web pages of publisher 104, the style elements used on the web pages of publisher 104, and all sorts of other information, that may be provided to collage system 240 by ad serving engine 1100. This data may be used by collage system 240 as a variable in the collage composition process, enabling an optimized alignment of the collage ads served on the web pages of publisher 104 to the styling of these web pages. As such, fonts, used in the collage ads, may be aligned to match the fonts, used on the web pages of publisher 104, as well as colors, styles, and many other design elements, to enable an optimal integration of the collage ads in the web pages of publisher 104.

In some implementations, consumer interface 1160 is the component that may interface with the user 101, through user device 102, to obtain or send information to and from ad serving engine 1100. For example, an ad consumer (e.g., user 101) may send a request for one or more collage ads (e.g., collage ad 133 of FIG. 1) to consumer interface 1160. The request may include information such as the website or other publication(s) of the publisher (e.g., publisher 104) requesting the collage ad, any information available to aid in selecting the collage ad, the number of collage ads requested, etc. In response, consumer interface 1160 may display one or more collage ads to user 101, as received from ad serving engine 1100. In addition, user 101 may send information about the performance of the collage ad, in the form of performance data 1161, back to the ad serving engine 1100 via the consumer interface 1160. This may include, for example, the statistical information described above in reference to statistics engine 1120. This performance data 1161 may, in some embodiments, be shared through advertiser admin system 1140 and publisher admin system 1150, and may, in these or other embodiments, be processed by ad serving engine 1100, combined with further and/or other performance data, and send to collage system 240, to act as input for mapping system 810, for example using weighting 815. User 101 may also, through consumer interface 1160, transmit user data, behavioral data and/or preference data (e.g., user data 1102). For example, user 101 may send information about socio-demographic characteristics, behavioral information such as time viewed, hover actions, click actions, etc., and preference data such as likes or dislikes, refresh requests, or other preference data related to the collage ad shown.

User data 1102 may, in some embodiments, on an aggregated and anonymized level be shared through advertiser admin system 1140 and publisher admin system 1150, and may, in these or other embodiments, be processed by ad serving engine 1100, combined with further and/or other user data, and send to collage system 240, to act as input for mapping system 810, for example using weighting 815.

More information on consumer interface 1160 can be found on the next pages of this application.

Though reference is made to collage ads, other forms of content, including other forms of sponsored content, may be delivered by the system 250. Collage ads may also include embedded information, such as links, meta-information, and/or machine executable instructions.

### VII. COLLAGE USER INTERFACE

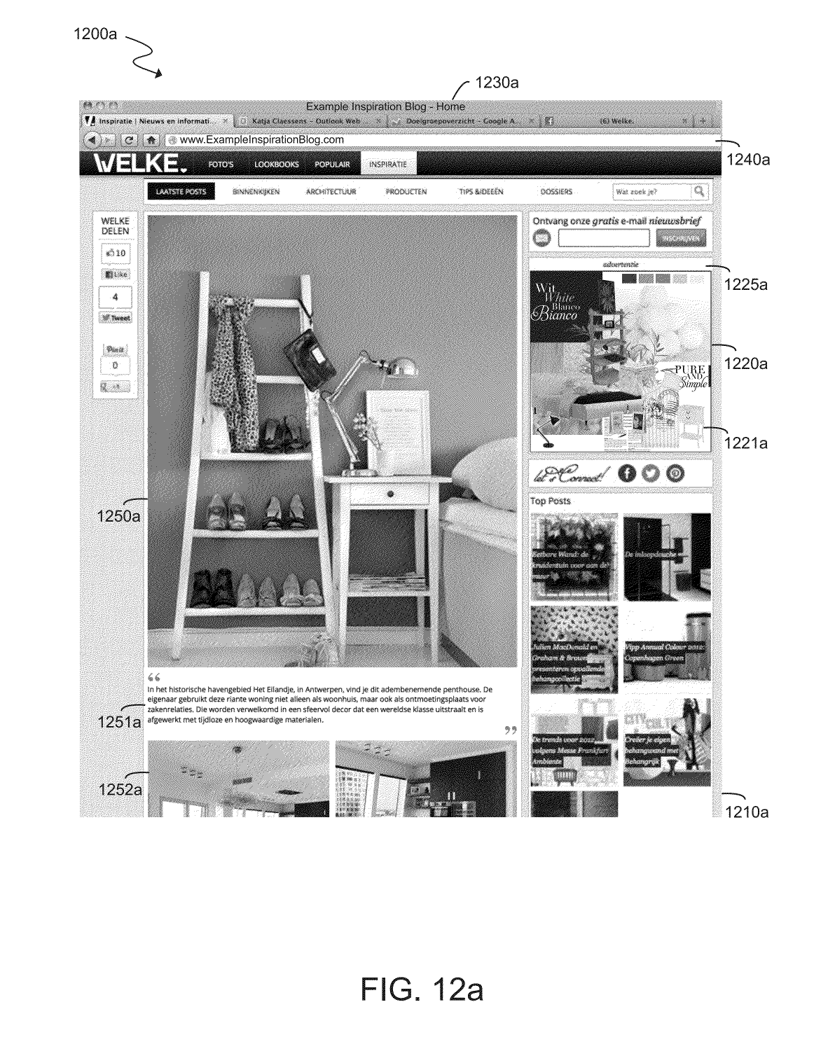

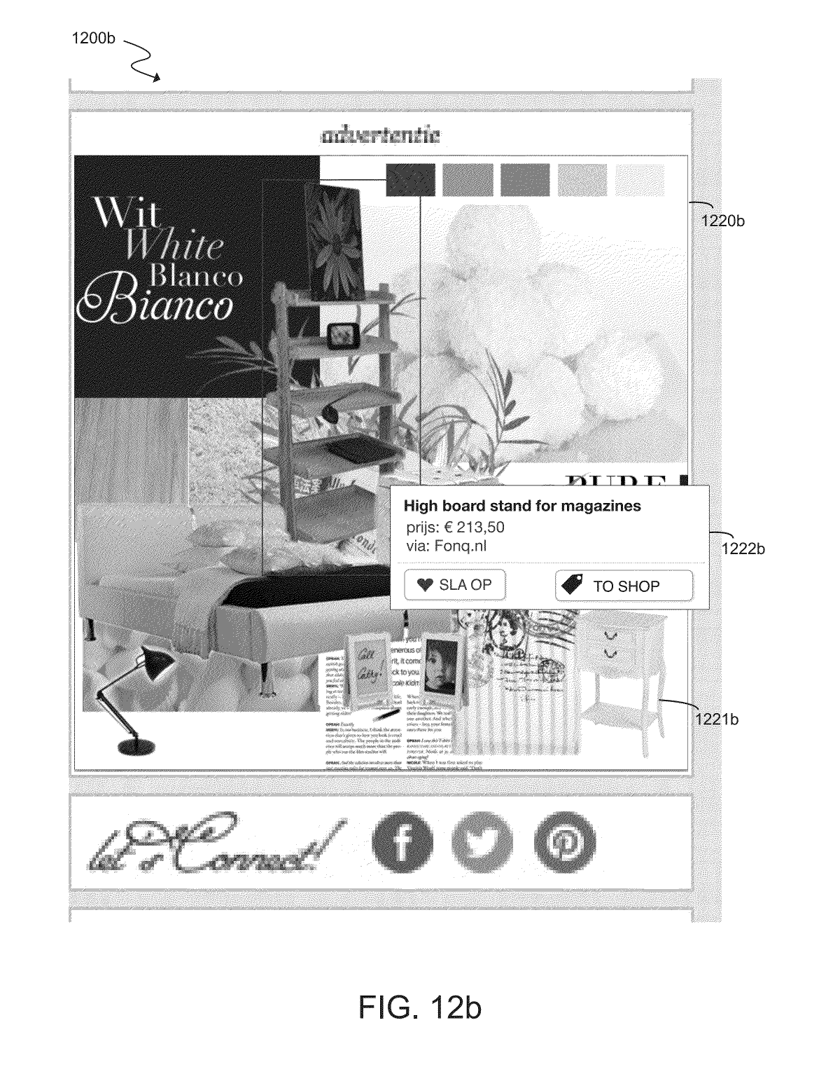

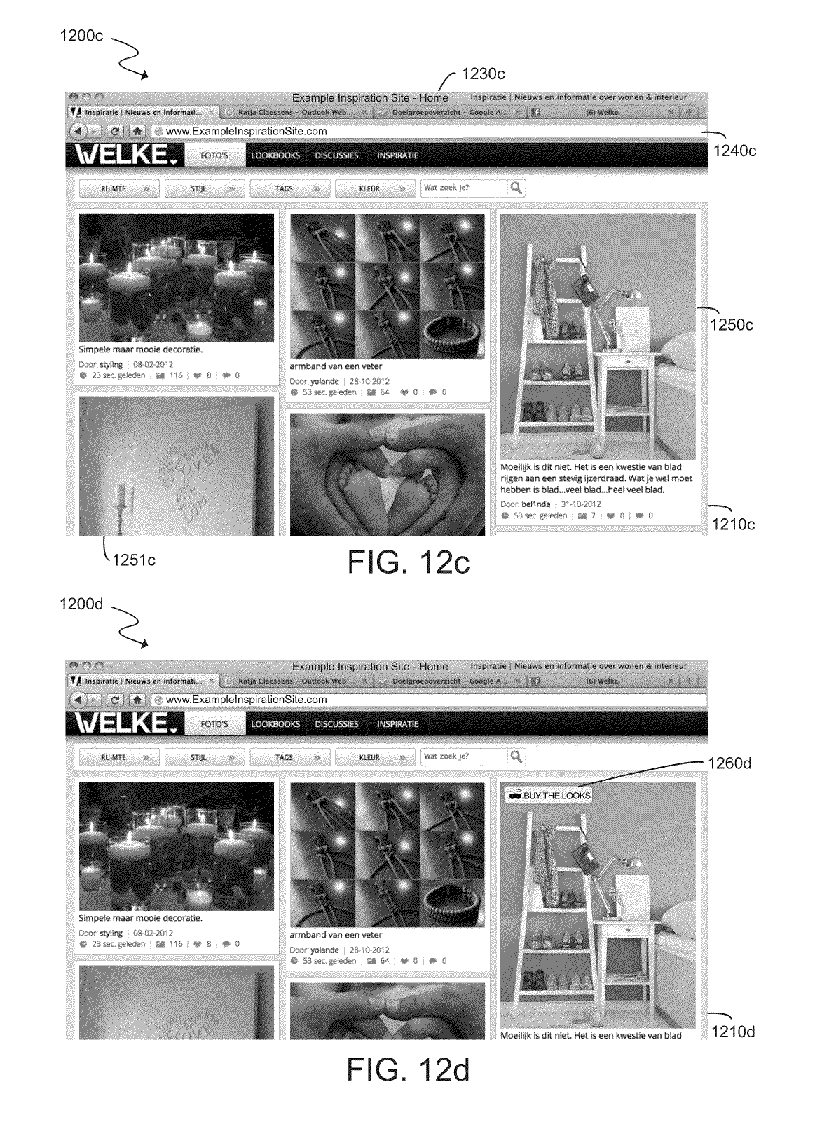

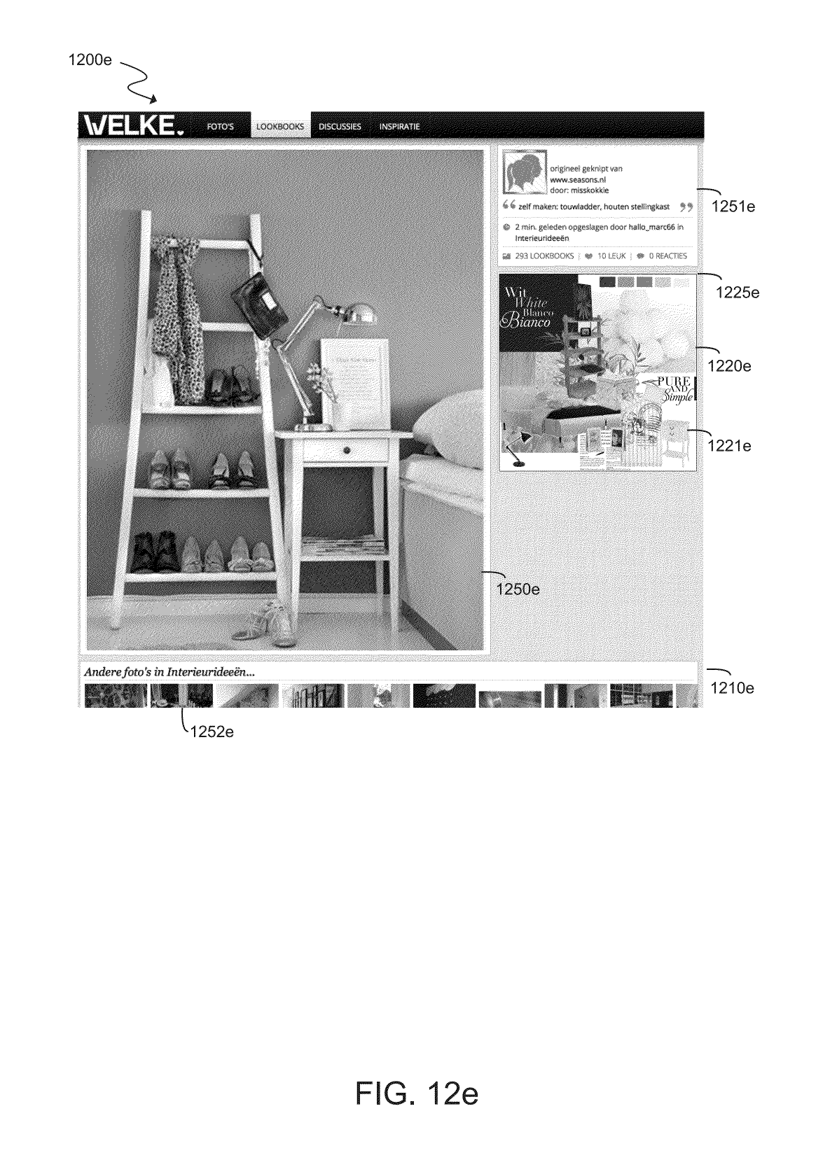

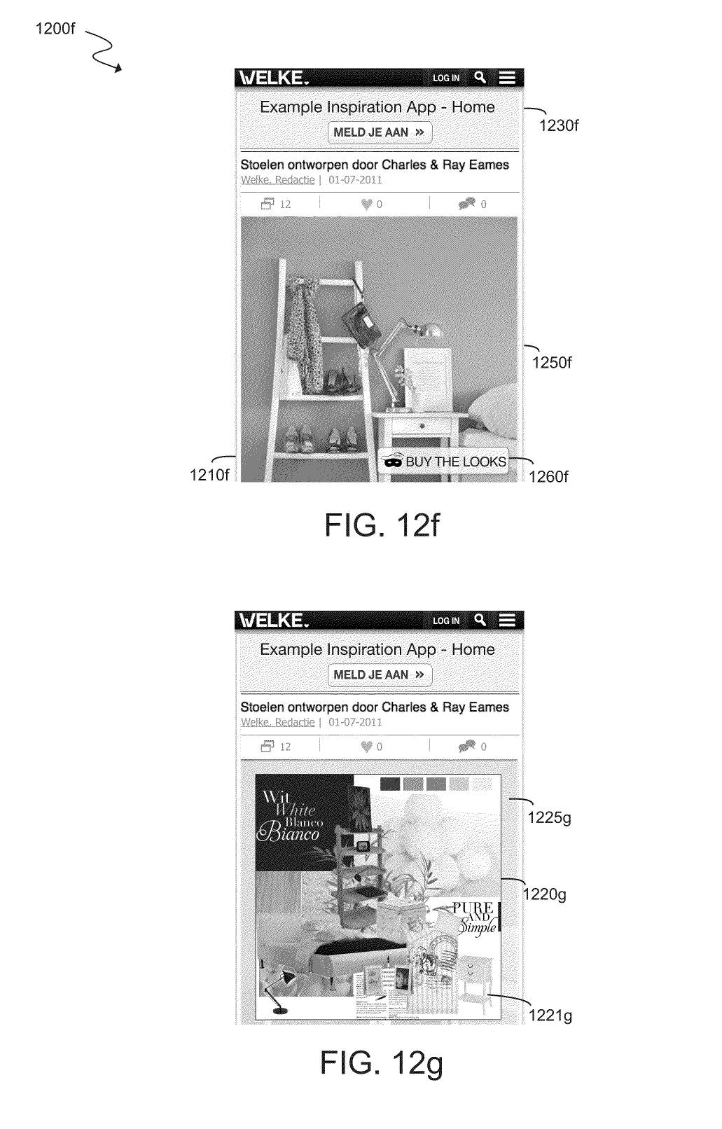

FIG. 12a shows an example screenshot 1200a of a web page 1210a that includes collage ad 1220a. As shown in FIG. 12a, the web page title 1230a is “Example Inspiration Blog Home”. The web page URL or hyperlink 1240a is “www.ExampleInspirationBlog.com”. The content, shown on ExampleInspirationBlog.com, may contain daily blog-like articles, always accompanied by large, inspirational photos, as shown by web page content 1250a, 1251 a, and 1252a. For example, user access device 102, as shown in FIG. 1 and FIG. 2, may display the web page 1210a.

User access device 102 may display a collage ad 1220a in an ad portion 1225a, included on web page 1210a along with other web page content (e.g., content 1250a, 1251a, and 1252a). As shown in FIG. 12a, the web page content 1250a, 1251 a, and 1252a relates to an interior design topic. For example, though not shown in FIG. 12a, the dominant color of this particular web page 1210a is white, the font used is Helvetica, the web page content item 1251a is a text element, containing interior design related terminology, and the web page content items 1250a and 1152a are images, coupled with metadata, related to interior design. Content item 1250a is the main and dominant image on the web page 1210a. Image 1250a contains several objects, among which are a lamp, a bed, a carpet, a nightstand and a photo frame. The dominant colors of image 1250a are, although not visible in FIG. 12a, beige, cream, white and brown, the style is “country living”. The collage ad 1220a shown in ad portion 1225a may consist of one or more ornamental templates, aligned with the color and font setting of the web page and aligned with the color(s) and style of image 1250a. Additionally, collage ad 1220a may contain product layers, in which products 1221a may be displayed, which are matched with the content items (e.g., query image content items 301) associated with content item 1250a on web page 1210a, following the methods described elsewhere and shown in FIG. 6a, 6b, 6c and FIGS. 10a and 10b. For example, collage ad 1220a may be composed of ornamental templates with a “country living” style, featuring beige, cream, white and brown as dominant colors. Text decorations may be selected that may use the Helvetica font. The product layers may feature products 1221a, closely matching the products, shown in image 1250a. For example, but without limitation, such close match may mean that similar products, from the same concept or concept group as the recognized objects in image 1250a may be displayed, with the same or similar colors, shapes, textures, etc. Thus, a similar or, if available in the product database (e.g., product databases 450), the same white nightstand may be shown, together with other products, resembling other objects in image 1250a, following the methods and procedures as disclosed in this application. Equally, resembling backgrounds, color swatches and other elements may be added, to arrive at an attractive collage ad 1220a.

Referring now to FIG. 12b, an example screen shot 1200b of a web page is shown, including collage ad 1220b. The screen shot 1200b shown has zoomed in on the collage ad 1220b and reflects the view when a user hovers a product layer with one of the products 1221b of collage ad 1220b. As shown, the product layer displays additional information 1222b on the product 1221b hovered, and emphasizes product 1221b visually. The additional information on product 1221b may contain a product description, a product price, the name of the merchant (e.g., advertiser 103), who provided the product 1221b and related information to IBAS 105 and who is selling the product 1221b, and a button, linking to a page URL of the product page on the site of the aforementioned merchant. Any additional or alternative information may be added to the information box, and any means of emphasizing the hovered product 1221b, visually or otherwise, may be employed, or this emphasis may be omitted altogether. Alternatively, the added information and/or emphasis may occur on other types of user actions, next to, or instead of, a mouse over. For example, but not meant to be limiting, a mouse-click or a finger tap may trigger the “hidden” information to appear. Further, all sorts of additional information may be shown on any of the user actions described before. For example, but without limitations, buttons may be shown to enlarge the collage ad 1220b, a refresh button may be shown, etc. More detail on this will follow below.

Referring now to FIG. 12c, an example screenshot 1200c of a web page 1210c is shown. As shown in FIG. 12c, the web page title 1230c is “Example Inspiration Site Home”. The web page URL or hyperlink 1240c is “www.ExampleInspirationSite.com”. The content strategy of ExampleInspirationSite.com may relate to the provision and sharing of photos that inspire other users, and thus, the content, shown on ExampleInspirationSite.com, may contain a continuous flow of large, inspirational photos, as shown by web page content 1250c and 1251c. For example, user access device 102, as shown in FIG. 1 and FIG. 2, may display the web page 1210c.

Referring now to FIG. 12d, an example screen shot 1200d of a web page 1210d of ExampleInspirationSite.com is shown. The screen shot 1200d shown reflects the view, when a user hovers one of the content items 1250d and 1251d on web page 1210d. This hovering may trigger the appearance of a button 1260d, with a link to the collage ad 1220e.

FIG. 12e shows an exemplary screen shot 1200e of a web page 1210e, appearing after a click of a user (e.g., user 101), on button 1260d, displayed on web page 1210d (FIG. 12d). As shown in FIG. 12e, web page 1210e may display a collage ad 1220e in an ad portion 1225e, included on web page 1210e, along with other web page content (e.g., content 1250e, 1251 e, and 1252e). The collage ad 1220e shown in ad portion 1225e may consist of one or more ornamental templates, aligned with the color(s) and style of the image 1150e, the dominant image on web page 1210e. Additionally, collage ad 1220e may contain product layers, in which products 1221e may be displayed, which are matched with the content items (e.g., query image content items 301) in image 1250e on web page 1210e, following the methods described elsewhere and shown in FIG. 6a, 6b, 6c and FIGS. 10a and 10b.

Although FIG. 12e shows an individual page, on which collage ad 1220e may be shown, one skilled in the art will understand that there are many other ways of displaying collage ad 1220e, after a click on button 1260d. For example, collage ad 1220e may also be displayed in an overlay over web page 1210d or 1210e, where the background (i.e., web page 1210d or 1210e) may be blurred to emphasize the overlay with collage ad 1220e.

Alternatively, collage ad 1220e may be displayed as the main content on web page 1210e, and thus occupying the position of image 1250e in FIG. 12e, whereas image 1250e occupies the smaller position of collage ad 1220e in FIG. 12e. Many other display options are possible. Further, although FIG. 12d shows a button on which a user (e.g., user 101) should click, many alternative user actions may trigger the appearance of collage ad 1220e.

FIG. 12f shows an exemplary screen shot 1200f of a page 1210f, resulting from a click of a user (e.g., user 101), on a button, displayed on the homepage of a mobile application, of which the app title 1230f is “Example Inspiration App Home”. The content, shown on Example Inspiration App, may contain daily articles, displayed in a design-savvy fashion, with large, inspirational photos, as shown by page content 1250f. For example, user access device 102, as shown in FIG. 1 and FIG. 2, may display the web page 1210f. As shown in FIG. 12f, page 1210f may contain a button 1260f, a finger tap on which results in the view, shown in FIG. 12g. This view may display a collage ad 1220g, which may consist of one or more ornamental templates, aligned with the color(s) and style of content item 1250f, in a similar fashion as has been described above.

Additionally, collage ad 1220g may contain product layers, in which products 1221g may be displayed, which are matched with the content items (e.g., query image content items 301) on page 1210f, following the methods shown in FIG. 6a, 6b, 6c and FIGS. 10a and 10b and described above.

Although several illustrative descriptions of user interfaces for the present invention have been provided for in FIGS. 12a-12g, many additional illustrations could be provided, using additional or alternative elements, under the invention. The descriptions provided above, with the accompanying figures, are meant to provide examples of one or a couple of the embodiments of the invention, and thus, are by no means representing the only implementations of the current invention.

Further, the spatial arrangements shown in FIGS. 12a-12g are just a couple of the possible divisions of space between the content, such as web content 1250, 1251, and 1252, and the collage ad 1220, and are just a couple of the possible arrangements of the collage ad 1220. Many other examples of displaying the collage ad 1220 are available, as one skilled in the art will understand.

Similarly, many additional features may be assigned to the collage ad. For example, but without limitation, the collage ad may contain an “enlarge” button, resulting in the display of the collage ad in full screen. Alternatively, the collage ad may contain a “refresh” button, by which a user (e.g., user 101), may request an alternative collage ad to be composed and shown. Further, the collage ad may contain approval and disapproval buttons, to enable user 101 to provide feedback on the accuracy of the similarity match, made for a particular product, shown in the collage ad.

Yet further, the collage ad may contain “like” and/or “dislike” buttons, or may provide user 101 with the opportunity to save the collage ad or portions thereof, or may enable user 101 to share the collage ad or any portion thereof with others. Still further, the collage ad may provide user 101 with the option to request a list display of the products, contained in the collage ad, for example to act as a shopping list, which subsequently could be saved or shared with others, or which could be used to request similar products to be shown. Even further, in some implementations, the collage ad may contain interactive elements, through which user 101 may post information. For example, these elements may enable user 101 to post a question about a product, shown in the collage ad, or to post an answer to a question of another user. In other implementations, such interactive elements may provide users, such as user 101 and others, with the option to interact with each other about the collage ad or any portion thereof.

In addition to using data from or associated with the image 1250, for composing a collage ad 1220, one or more embodiments provide for the user (e.g., user 101) to submit additional data that may formulate and guide the collage composition. In one embodiment, user 101 is given the option to select a portion of the image. In response, interactive elements as described above may be provided, enabling user 101 to specify additional information. For example, user 101 may provide text that describes or classifies the selected image portion further, to enable a better matching collage ad 1120. Alternatively, a game-like setting, using interactive elements, enabling users to answer a question (e.g., “what object is this?”) may be implemented. Data, collected from users, may be stored in a separate database, to continuously improve the image similarity matching algorithms, contained in IBAS 105.

Although several illustrative examples have been given in the previous paragraphs, many more examples of alternate or additional features may be added, all within the scope of the invention.

### VIII. HARDWARE OVERVIEW

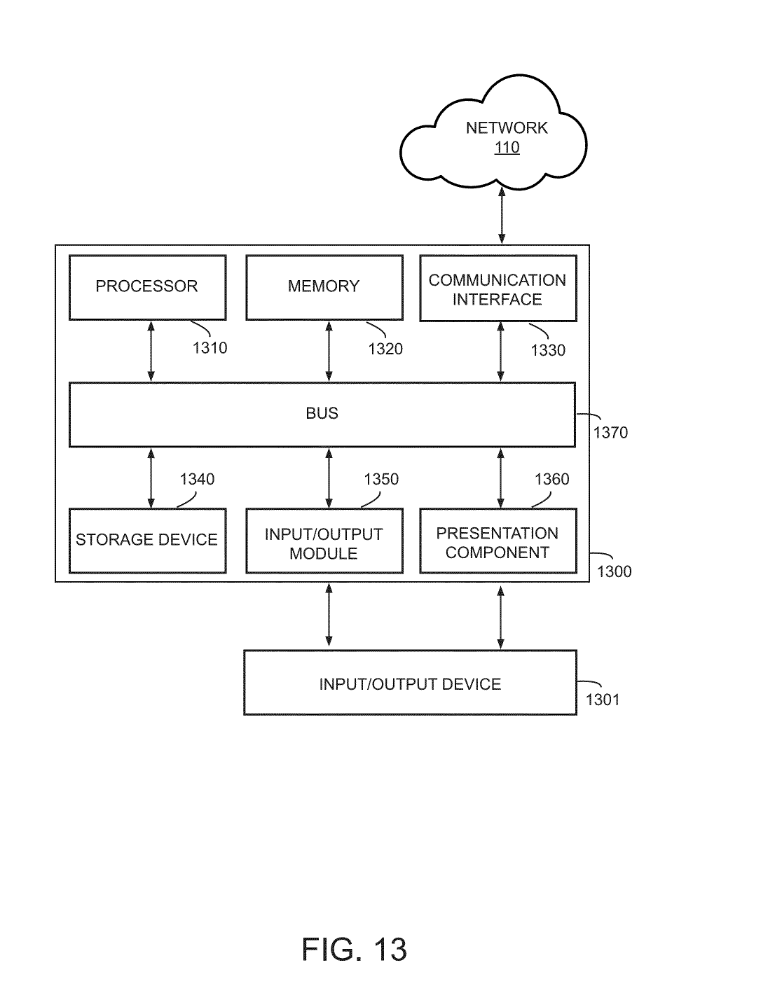

FIG. 13 is a block diagram of an exemplary operating environment and processing device that may be used to execute the methods and processes disclosed in this application. One or multiple systems 1300 may be used for the operations described in association with the methods shown in FIGS. 6a, 6b, and 6c and FIGS. 10a and 10b, according to some implementations. For example, one or more systems 1300 may be included in either or all of the components of IBAS 105, the components of publisher 104, and the components of advertiser 103.

System 1300 is but one example of a suitable computing environment and is not intended to suggest any limitation as to the scope of use and functionality of the invention. Neither should system 1300 be interpreted as having any dependency or requirement relating to any one or combination of modules and/or components illustrated.

System 1300 may include one or more processors 1310, memory 1320, one or more communication interfaces 1330, one or more storage devices 1340, one or more presentation components 1350, and one or more input/output modules 1360. Each of the components 1310, 1320, 1330, 1340, 1350 and 1360 may be interconnected using one or more system busses 1370.

Although the various blocks of FIG. 13 are shown with lines for the sake of clarity, in reality, delineating various modules is not so clear, and metaphorically, the lines would more accurately be fuzzy. Thus, FIG. 13 is merely illustrative for an exemplary computing device, which may be used with one or more embodiments. Distinction is not made between such categories as “workstation”, “server”, “laptop”, “hand-held device”, “smart-phone”, “navigation device”, etc., as all are within the scope of FIG. 13.

Components 1310, 1320, 1330, 1340, 1350, 1360 and 1370 may take any form, as one skilled in the art will understand. For example, processor 1310 may be a single-threaded processor, a multi-threaded processor, or any other type of processor. Memory 1320 may be a computer-readable medium, a volatile memory unit, a non-volatile memory unit, or any other memory unit. Communication interface 1330 may encompass any type of interface, able to facilitate communication to any type of external element or network, such as network 110. Storage device 1340 may encompass any device, capable of providing mass storage for system 1300. Input/output module 1350 may encompass any device, capable of providing input/output operations for system 1300 to and from any form of input/output device (e.g., input/output device 1301). Finally, presentation component 1360 may include a display device, an auditory device, a printing module, a sensory device, and/or any other device, capable of presenting output for system 1300.

The contents of system 1300, shown in FIG. 13, may not be the only contents of system 1300 and/or may be replaced by other components.

The features described above may be implemented in digital electronic circuitry, or in computer hardware, firmware, software, or in combinations of them. The method steps of the invention may be performed by processing units executing a program of instructions to perform functions of the described implementations by operating on input data and generating output. The described features may be implemented advantageously in one or more computer programs that are executable on a programmable system including at least one central processing unit, to receive data and instructions from, and to transmit data and instructions to, a data storage system, at least one input device, and at least one output device.

The features may be implemented in a computer system that includes a back-end component, such as a data server, or that includes a middleware component, such as an application server or an Internet server, or that includes a front-end component, such as a client computer, a mobile device or any other front-end component, having a graphical user interface or an Internet browser, or any combination of them. The components of the system may be connected by any form or medium of digital data communication such as a communications network. Examples of communications networks include, e.g., a LAN, a WAN, and the computers and networks forming the Internet, among many others. Any type of communication interface 1330 may interface with such communication network (e.g., network 110).

### IX. ALTERNATIVE EMBODIMENTS OF THE PROPOSED METHOD AND SYSTEM

Any of the embodiments described herein may have applications to electronic commerce. More specifically, with reference to FIG. 2, one or more embodiments provide for the use of an IBAS 105 in which content items include commercial content containing images of merchandise and products for sale. E-commerce content items include records that may be stored or that may be hosted or provided at other sites, including, for example, online commerce sites, and auction sites. Other embodiments provide for processing and use of images that are not inherently for use in commercial transactions, and are created with alternative purposes (such as to entertain or to inform). Yet other embodiments provide for the creation of collages that are not pre-dominantly meant to be an advertisement. Such collages may be created by using a set of product images and textual information, and may or may not use one or more ornamental layers, e.g., for use on any page of a web site, such as a web shop. Such collage may act as a welcome page, enabling users (e.g., user 101) to visually navigate through the most important products of that particular web shop. Other implementations may use non-commercial collages, acting as a visually appealing display of products, which might otherwise be displayed in a list-format. For example, a programmatically created collage, using IBAS 105, might replace the list view of products, added to a shopping cart of a web shop by a user (e.g., user 101), thus providing user 101 with an attractive display of the products to be bought, and the level of fit between these products. In such view, additional products may be added, based upon their similarity or fit with the products, already selected in the shopping cart, for recommendation purposes. Similarly, a wish list may be shown in an appealing collage, as well as an overview of recommended products, products that other users bought or viewed, and/or other product recommendations.

Accordingly, non-advertising based implementations may be composed in one or several of the embodiments described in the current application. For example, but without limitation, image search applications, that enable the likewise search of images selected for inclusion in a collage, or that enable the provision of an image as input for a similarity search on a database of images (e.g., image databases 440, filled with, e.g., web image content items 311), a database of product images (e.g., product databases 450, filled with, e.g., product image content items 321), or any third party content area, may be made part of one or several embodiments.

Similarly, partial search, in which a part of an image may be identified or manually selected by a user (e.g. user 101), for example by dragging the mouse over a product, contained in the image, and/or by dragging a selection box around a region of the image, may be made part of one or several of the implementations, described in this application. The selected area and/or product and/or object in the image may act as an input search criterion for a similarity search, employed by IBAS 105. Such search may be employed from an initial region selection of an image, or may be employed as an improved search, after a first collage, created by IBAS 105, has been served.

In addition to using data from or associated with an image, one or more embodiments provide for a user (e.g., user 101) to submit additional data that formulates a query. In one embodiment, user 101 may select an image portion (e.g., a high heel pump on an image with a full-body shot of a woman). In response, user 101 is provided an interactive window, enabling user 101 to specify additional information, such as additional text. For example, user 101 may seek to provide text that describes or classifies the selected region further (e.g. “high heels with ankle strap”). As an addition or alternative, user 101 may specify a preferred color, either visually or through text.

In response to the query, manually enriched by user 101, the IBAS 105 may return images (e.g., products 730) in a collage (e.g., collage 830) that correspond to or are otherwise determined to be similar in appearance or design or even style, as the region of the user's selection and/or the color selected or identified.

Methods and systems described in this disclosure may, together, simultaneous or separately, be employed in other embodiments. For example, the image procurement & pre-process system 210 and associated methods may be employed for embodiments, facilitating quick image procurement and/or automated foreground/background separation, together with or separate from other systems, methods and facilities described herein. The storage & indexing system 220 and associated methods may facilitate quick and reliable image retrieval in embodiments, containing only some, all or none of the other systems and methods described herein. Storage & indexing system 220 and associated methods may also be part of embodiments facilitating (real-time) object and/or concept recognition, and may, together with, for example, image similarity matching system 230 and associated methods, facilitate duplicate or near-duplicate recognition and retrieval. Image similarity matching system 230 and associated methods may, for example, be made part of embodiments, featuring reliable database similarity search techniques and/or may, together with collage system 240 and associated methods, be used in embodiments, facilitating programmatic document, page, and display design services. Finally, advertising system 250 may, together with or separate from some or all of the systems, described in this disclosure, facilitate alternative forms of ad serving and may facilitate forms of alternative ad serving, under some embodiments.

Methods such as described in this application may be performed using modules and components described with other embodiments of this application. Accordingly, reference may be made to such other modules or components for purposes of illustrating a suitable component for performing a step or sub-step.

In one embodiment, such a step may provide that images on a page of a remote web site or other form of remote publication may be analyzed or inspected for objects of interest, e.g., potential content items for inclusion in one of the embodiments, next to, or instead of, the use of product databases 450 and/or image databases 440.

As an addition or alternative embodiment, manual processes may be performed to enrich or enhance one or more programmatic embodiments described. For example, the results of any identification and/or any step in the methods, shown in FIGS. 6a, 6b, and 6c and FIGS. 10a and 10b, may be presented to an editor for manual confirmation and/or enhancement. As another example, users may be asked to annotate images, resulting in information that may be used to enhance the knowledge about the image itself or about the objects contained therein. Such enrichment may be used in a learning machine set-up, providing the ISME 720 of FIG. 7 and/or the mapping system 810 of FIG. 8 with human input, to be employed to optimize the matching and mapping results on a continuous basis.

Furthermore, while embodiments described herein and elsewhere provide for searching for visual characteristics of a query image to identify other images, such as web image content items 321, product image content items 311, and/or ornamental elements in templates 740, an embodiment contemplates searching of elements, other than images. For example, next to or instead of images, texts and/or text snippets may be queried, as well as video fragments and any other form of interactive content.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

Accordingly, it is intended that the scope of the invention be defined by the following claims and their equivalents. Furthermore, it is contemplated that a particular feature described either individually or as part of an embodiment herein can be combined with other individually described features, or parts of other embodiments, even if the other features and embodiments make no mention of the particular feature. Thus, the absence of describing combinations should not preclude the inventor from claiming rights to such combinations.

What is claimed is:

1. A method for generating image-based contextual advertising through programmatically composed image collages comprising:
a procurement and indexing process, extracting and indexing at least a portion of content data from a plurality of images and their associated content, using one or more steps comprising:
procuring and indexing query images; and
procuring and indexing ad components;
an image similarity matching process, wherein the extracted and indexed content data of the one or more procured ad components are matched with the extracted and indexed content data of the one or more procured query images and wherein the one or more ad components that are contextually relevant to the query image are determined, based on the extracted and indexed content data;
the image similarity matching process, determining from one or more template databases the one or more structural templates defining a layout of regions in a display area, wherein each of the regions is associated with a set of one or more image selection criteria and one or more image positioning criteria;
the image similarity matching process, combining the one or more identified ad components and the one or more structural templates, ascertaining a respective image layer for each of the regions of the structural template, wherein the ascertaining comprises for each of the layers assigning a respective ad component to the respective region in accordance with the set of image selection criteria and the set of image positioning criteria;
the image similarity matching process, outputting a set of rendering parameter values, each of which specifying a composition of one of the determined ad components in the display area, in accordance with the set of image selection criteria and the set of image positioning criteria;
a collage composition process, composing a collage in accordance with the rendering parameter values; and
a distribution process, transmitting the programmatically composed collage, the contents of which are based at least in part on the information extracted and indexed from the query image, for display to a user.

2. The method of claim 1, wherein the procurement and indexing process further comprises: extracting and indexing images, procured by crawling one or more large scale image databases, whereby the extracted and indexed content data from such web images is transferred to enrich the content data, extracted and indexed from the one or more query images.

3. The method of claim 1, wherein the procurement and indexing process further comprises: pre-processing the obtained one or more ad components, this pre-processing comprising the foreground from background segmentation of the one or more ad components.

4. The method recited in claim 1, wherein the procurement and indexing process further comprises: extracting content items, wherein at least a portion of the data extracted is from a non-text nature or data derived thereof, performing image analysis and image recognition methods on the textual data, the metadata, the non-text data, or on any combination thereof, to recognize the content, context and/or concept associated with the content items extracted, to be used for composing and presenting a collage to a user, based at least in part on the recognized content, context and/or concept of the data extracted from the non-text nature or data derived thereof.

5. The method of claim 1, wherein the image similarity matching process further comprises: identifying near-duplicate or duplicate images in one or more image databases and transferring content data and/or recognition data or derivatives thereof from the one or more identified duplicate or near-duplicate images to the one or more query images.

6. The method of claim 1, wherein the ad components procured, indexed, and matched encompass items of commerce, consisting of product images and associated content such as product information, product source information, etc., from merchants.

7. The method of claim 1, wherein the image similarity matching process further comprises: matching from one or more template databases one or more decorative templates or decorative template components with the extracted and indexed content data of the one or more procured query images and determining the one or more decorative templates or template components that are contextually relevant to the query images, based on the extracted and indexed content data, to be assigned to one or more structural regions in the display area and to be combined with the one or more ad components into a collage.

8. The method of claim 1, wherein the collage composition process further comprises: following a set of mapping rules, ascertaining that
universal and immutable natural laws, shaping the expectations of humans, are taken into account, in such a way that
inappropriate relative sizing of ad components and/or template elements is prevented;
inappropriate positioning and relative positioning of ad components and/or template elements is prevented; and
inappropriate combination of ad components and/or template elements is prevented.
common design rules, principles and tactics, shaping the level of attractiveness as perceived by humans, are taken into account, in such a way that the resulting one or more collages are pleasing the human eye and repetition of the same or similar ad components and/or template elements is prevented; and
a non-computationally expensive and quick procedure is assured.

9. The method of claim 1, wherein the collage is displayed as a programmatically composed, contextually relevant collage ad, based at least in part on the data extracted and indexed from the query image procured.

10. The method of claim 1, wherein the distribution process further comprises: transmitting the collage over a network, e.g., the internet, and serving the collage as a contextually relevant image-based collage ad to the user.

11. The method recited in claim 1, further comprising a feedback process, utilizing user data, performance data and third party data to continuously and dynamically optimize the algorithms, used in the image similarity matching, collage composition and distribution processes.

12. A system configured for generating image-based contextual advertising through programmatically composed image collages, the system comprising:
an image procurement and pre-process sub-system that is configured to procure at least a portion of content data from a plurality of images and their associated content, among which are query images and ad components;
a storage and indexing sub-system that is configured to extract, index and store at least a portion of the procured content data;
an image similarity matching sub-system, configured to match the extracted and indexed content data of the one or more ad components procured with the extracted and matched content data of the one or more query images procured, and to determine the one or more ad components that are contextually relevant to the query image, based on the extracted and indexed content data;
the image similarity matching sub-system, that is further configured to determine from one or more template databases the one or more structural templates defining a layout of regions in a display area, wherein each of the regions is associated with a set of one or more image selection criteria and one or more image positioning criteria;
the image similarity matching sub-system, configured to combine the one or more identified ad components with the one or structural templates, ascertaining a respective image layer for each of the regions of the structural template, wherein the ascertaining comprises for each of the layers assigning a respective ad component to the respective region in accordance with the set of image selection criteria and the set of image positioning criteria;
the image similarity matching sub-system, further configured to output a set of rendering parameter values, each of which specifying a composition of one of the determined ad components in the display area, in accordance with the set of image selection criteria and the set of image positioning criteria;
a collage composition sub-system, configured to compose and populate a collage in accordance with the rendering parameter values; and
an advertising sub-system, configured to distribute the programmatically composed collage, the contents of which are based at least in part on the information extracted and indexed from the query image, for display to a user.

13. The system of claim 12, wherein the image procurement and pre-process sub-system is further configured to procure images and associated data, by crawling one or more large scale image databases, and wherein the storage and indexing sub-system is further configured to extract and index content data from the images, procured by crawling image databases, utilizing this data for the enrichment of the content data, extracted and indexed from the query images.

14. The system of claim 12, wherein the image procurement and pre-process component is further configured to pre-process the procured ad components, this pre-processing comprising the foreground from background segmentation of the ad components.

15. The system recited in claim 12, wherein the storage and indexing sub-system is further configured to extract at least a portion of data from a non-text nature or data derived thereof, containing an image analysis and recognition sub-component for analyzing the textual data, the metadata, the non-text data, or any combination thereof, recognizing the content, context and/or concept associated with the content data extracted, to be used for composing and presenting a collage to a user, based at least in part on the recognized content, context and/or concept of the data extracted from the non-text nature or data derived thereof.

16. The system of claim 12, wherein the image similarity matching sub-system is further configured to identify near-duplicate or duplicate images in one or more image databases and to transfer content data and/or recognition data or derivatives thereof from the one or more identified duplicate or near-duplicate images to the one or more query images.

17. The system of claim 12, wherein the image similarity matching sub-system is further configured to match one or more decorative templates or decorative template elements from one or more template databases with the extracted and indexed content data of the one or more query images and to determine the one or more decorative templates or template elements that are contextually relevant to the query images, based on the extracted and indexed content data, to be assigned to one or more structural regions in the display area and to be combined with the one or more ad components into a collage.

18. The system of claim 12, wherein the collage composition sub-system is further configured to facilitate a collage composition process that follows a set of mapping rules, ascertaining that universal and immutable natural laws, shaping the expectations of humans, are taken into account, as well as common design rules, principles and tactics, shaping the level of attractiveness as perceived by humans, and that a non-computationally expensive and quick procedure is assured.

19. The system of claim 12, wherein the advertising sub-system is further configured to distribute the collage composed over a network, e.g., the internet, and to serve the collage as a contextually relevant image-based collage ad to the user.

20. The system recited in claim 12, further configured to facilitate a feedback process, utilizing user data, performance data and third party data to continuously and dynamically optimize the algorithms, used by the image similarity matching, collage composition and advertising sub-systems.
